(19) United States
(12) Patent Application Publication
(10) Pub. No.: US 2014/0232945 A1
(43) Pub. Date: Aug. 21, 2014

(54) DISPLAY DEVICE AND TELEVISION DEVICE

(71) Applicant: Sharp Kabushiki Kaisha, Osaka-shi, Osaka (JP)

(72) Inventors: Makoto Uno, Osaka-shi (JP); Yoshikazu Ichinari, Osaka-shi (JP)

(21) Appl. No.: 14/347,318

(22) PCT Filed: Sep. 21, 2012
(86) PCT No.: PCT/JP2012/074218

§ 371 Date: Mar. 26, 2014

(30) Foreign Application Priority Data
Sep. 30, 2011 (JP) 2011-217480

(51) Int. Cl. F21V 8/00; H04N 5/66

(52) U.S. Cl. CPC G02B 6/0081; G02B 6/0086; G02B 6/0085; H04N 5/66
USPC 348/739; 362/634; 362/631

(57) ABSTRACT

A liquid crystal display device 10 according to the present invention includes LEDs 17, a liquid crystal panel 11, a light guide plate 16, a holding member HM, a screw member SM, and a screw attachment portion 21. The light guide plate 16 is arranged on a side opposite to a display surface 11c side of the liquid crystal panel 11 with an end surface thereof being opposite the LEDs 17. The holding member HM includes a frame 13 and a chassis 14 that holds the liquid crystal panel 11 and the light guide plate 16 and houses the LEDs 17 therebetween. The screw member SM is attached to outer peripheral portions of the frame 13 and the chassis 14 and holds the frame 13 and the chassis 14 in an assembled condition. The screw attachment portion 21 is arranged on the frame 13 and held by the screw member SM with the chassis 14 between the screw attachment portion 21 and the fixing member SM. The screw attachment portion 21 protrudes from an inner surface of the frame 13 and extends along a side of the outer peripheral portion of the frame 13.

### TECHNICAL FIELD

The present invention relates to a display device and a television device.

### BACKGROUND ART

A liquid crystal panel used for a liquid crystal display device, such as a liquid crystal television, does not emit light, and thus a backlight unit is required as a different lighting device. One example of such a liquid crystal display device is disclosed in Patent Document 1. The backlight unit included in this kind of liquid crystal display device can be roughly categorized into a direct type or an edge-light type depending on the structure. It is preferable to use an edge-light type backlight unit to reduce a thickness of the liquid crystal display device.

### RELATED ART DOCUMENT

### Patent Document

Patent Document 1: Japanese Unexamined Patent Application Publication No. 2005-107499

### Problem to be Solved by the Invention

In the liquid crystal display device disclosed in Patent Document 1, a liquid crystal panel is sandwiched between a panel holding member arranged on a front surface of the liquid crystal panel and a panel-receiving member arranged on a rear surface of the liquid crystal panel. Each of the panel holding member and the panel-receiving member has an L-like shape in a cross-section and includes a side plate. The side plates of the panel holding member and the panel-receiving member are fixed to a sidewall of a chassis of the backlight unit with screws that are screwed to the sidewall from the side of the backlight unit.

If a demand for a reduction in production cost or in thickness is raised, a configuration without the panel-receiving member on the rear side may be considered. For example, the liquid crystal display device may have a configuration in which the liquid crystal panel and a light guide plate may be held between the panel-pressing member and the chassis. However, if the panel-receiving member is eliminated, the overall strength may be decreased by a strength that would have been provided by the panel-receiving member. Because the positional relationship between the liquid crystal panel and the light guide plate in an overlapping direction thereof is maintained by the panel-receiving member, the positional relationship may be unstable without the panel-receiving member. As a result, the display quality may decrease. Furthermore, if screws are attached from the side as mentioned above, the screws do not provide direct retention force to the liquid crystal panel and the light guide plate. Therefore, the retention force may insufficient in such a fixing structure. Moreover, workability may be poor in the above fixing structure because positioning the side plates of the members is difficult when they are aligned to each other.

### DISCLOSURE OF THE PRESENT INVENTION

The present invention was made in view of the foregoing circumstances. An object of the present invention is to improve strength and enhance display quality.

### Means for Solving the Problem

A display device according to the present invention includes a light source, a display panel, a light guide plate, a holding member, a fixing member, and a fixing member attachment portion. The display panel is configured to provide a display using light from the light source. The light guide plate is arranged on a side opposite to a display surface side of the display panel. The light guide plate has an end surface arranged opposite the light source. The holding member includes holding portions that holds the display panel and the light guide plate from the display surface side and the side opposite to the display surface side and houses the light source therebetween. The fixing member is attached to an outer peripheral portion of each of the holding portions and holds the holding portions in an assembled condition. The outer peripheral portion of each of the holding portions surrounds the display panel. The fixing member attachment portion is arranged on one of the holding portions and held by the fixing member with another one of the holding portions sandwiched between the fixing member attachment portion and the fixing member. The fixing member attachment portion protrudes from an inner surface of the one of the holding portions and extends along a side of the outer peripheral portion of the one of the holding portions.

According to this configuration, the light emitted from the light source enters the light guide plate from the edge surface thereof opposite the light source and passes through the light guide plate toward the display panel. An image is displayed on the display panel using the light. Unlike the conventional configuration in which the panel-receiving member is arranged between the liquid crystal panel and light guide plate, the display panel and the light guide plate are arranged so as to overlap each other and held by the holding member. Specifically, the holding portions included in the holding member sandwich the display panel and the light guide plate from the display surface side and the side opposite from the display surface side. Therefore, the overall strength may be decreased by the elimination of the panel-receiving member. In addition, the positional relationship between the liquid crystal panel and the light guide plate in the overlapping direction thereof, which can be maintained by the eliminated panel-receiving member, may not be maintained in a stable condition. This unstable relationship may deteriorate the display quality. However, according to the above configuration, the fixing member attachment portion protrudes from the inner surface of the one of the holding portions and extends along the edges of the outer peripheral portion of the one of the holding portions, and the fixing member is attached to the fixing member attachment portion with the other one of the holding portions located between the fixing member attachment portion and the fixing member. Therefore, strength of the one of the holding portions improves and accordingly the entire strength also improves. Deformation is less likely to occur in the one of the holding portions in this configuration, and thus an improved retention can be applied to the display panel and the light guide plate that are held between the one of the holding portions and the other one of the holding portions. Since the positional relationship between the display panel and the light guide plate can be stabilized, the display quality can be enhanced.

The following configurations are preferable as aspects of the present invention.

(1) The fixing member may be attached to the outer peripheral portion of each of the holding portions in an overlapping direction of the display panel and the light guide plate. In this configuration, the fixing member applies retention to the display panel and the light guide plate from the overlapping direction through the holding portions. Therefore, the positional relationship between the display panel and the light guide plate in the overlapping direction can be stabilized and thus the display quality is further improved.

(2) The one of the holding portions may be arranged on the display surface side with respect to the display panel. The other one of the holding portions may be arranged on the side opposite to the display surface side with respect to the light guide plate. The fixing member may be attached to the outer peripheral portion of each of the holding portions from the side opposite to the display surface side. In this configuration, in the production process, the display panel, the light guide plate, and the other of the holding portions, which is arranged on the side opposite from the display surface side, are attached to the one of the holding portions, which is arranged on the display surface side, in this sequence. Therefore, higher assembling workability and productivity can be obtained.

(3) The holding portions may be exterior members that provide an appearance of the display device. In the above configuration in which the holding members serve as the exterior member and a cabinet is not provided, higher strength is required compared to the configuration in which a cabinet as an exterior member is provided in addition to the holding members. However, the strength of the one of the holding members can be sufficiently increased by the fixing member attachment portion in the above configuration. In addition, the elimination of the cabinet can reduce production cost of the display device and reduce thickness of the display device.

(4) The one of the holding portions may include a panel holding portion that presses the display panel from the display surface side and include a sidewall that protrudes from an area of the panel holding portion that corresponds to the outer peripheral portion of the one of the holding portions toward the side opposite to the display surface side. The fixing member attachment portion with the light source attached thereto continues to the sidewall with a space provided between the fixing member attachment portion and the panel holding portion. In this configuration, heat generated by the lightened light source is transferred to the fixing member attachment portion to which the light source is attached and then transferred to the sidewall that continues from the fixing member attachment portion. The heat is thus released to the outside. Since the space is provided between the fixing member attachment portion and the panel holding portion, the heat is less likely to be transferred to the panel holding portion. The panel holding portion that holds the display panel from the display surface side is an exterior member and exposed to the outside, and thus an external object is more likely to touch. However, the temperature increase is suppressed as described above and thus the external object that touches the panel holding portion is less likely to be affected by heat.

(5) The fixing member attachment portion may protrude inward from an inner surface of the sidewall with a space provided between the fixing member attachment portion and the inner surface of the sidewall. The other one of holding portions may include a positioning portion arranged in the space provided between the fixing member attachment portion and the inner surface of the sidewall. In this configuration, in the assembly process of the other of the holding portions, the positioning portion is inserted in the space provided between the fixing member attachment portion and the sidewall, and thus the other of the holding portions can be positioned with respect to the one of the holding portions. Therefore, high assembling workability can be achieved.

(6) The display device may further include a light source attachment member including a light source attachment portion to which the light source is attached and a heat dissipation portion. The heat dissipation portion may extend from the light source attachment portion along a surface of the outer peripheral portion of the other one of the holding portions. The heat dissipation portion may be sandwiched between the outer peripheral portion of the other one of the holding portions and the fixing member attachment portion and held by the fixing member. In this configuration, the light source is attached to the fixing member attachment portion via the light source attachment member. Heat generated by the lightened light source is transferred from the light source attachment portion to the heat dissipation portion. The heat is then transferred not only to the sidewall that continues to the fixing member attachment portion but also to the outer peripheral portion of the other of the holding portions. The heat is thus released to the outside. Therefore, heat is further less likely to be transferred to the panel holding portion.

(7) The one of the holding portions may be arranged on the display surface side with respect to the display panel. The other one of the holding portions may be arranged on the side opposite to the display surface side with respect to the light guide plate. The fixing member may be attached to the outer peripheral portion of each of the holding portions from the side opposite to the display surface side. With this configuration, the fixing member is hardly recognized from the display surface side, and thus display device obtains a good appearance. In addition, in assembling processes, the display panel, the light guide plate, and the other of the holding portions, which is arranged on the side opposite from the display surface side, are attached to the one of the holding portions, which is arranged on the display surface side, in this sequence. The fixing member is then attached to the fixing member attachment portion from the side opposite from the display surface side. Therefore, high assembling workability and productivity can be obtained.

(8) The fixing member attachment portion may extend along the sides of the outer peripheral portion of the one of the holding portions over an entire length thereof and may continue to an inner surface of the outer peripheral portion of the one of the holding portions. With this configuration, strength of the one of the holding portions further improves.

(9) The one of the holding portions may be arranged on the display surface side with respect to the display panel and has a frame-like shape so as to surround the display panel. The one of the holding portions assembled from a plurality of holding pieces that are bar parts of the one of the holding portions. The fixing member attachment portion may include a plurality of fixing member attachment portions, adjacent ones of which are in contact with each other, each of the plurality of fixing member attachment portions is included in corresponding one of the holding pieces. In this configuration, the one of the holding portions having a frame-like shape includes frame pieces corresponding to the respective sides, and the each frame piece includes the fixing member attachment portion. Therefore, the one of the holding portions with a complex shape can be easily produced. In addition, the adjacent fixing member attachment portions are in contact with each other and thus strength of the one of the holding portions further improves.

(10) The display device may further include a light source attachment member to which the light source is attached. The fixing member may be attached to the fixing member attachment portion with the outer peripheral portion of the other one of the holding portions and the light source attachment member sandwiched between the fixing member and the fixing member attachment portion. With this configuration, the fixing member can hold not only the holding members in an assembled condition but also the light source attachment member.

(11) The light source attachment member may include a heat dissipation portion and a light source attachment portion to which the light source is attached. The heat dissipation portion may extend along the surface of the outer peripheral portion of the other one of the holding portions. The heat dissipation portion may be sandwiched between the outer peripheral portion of the other one of the holding portions and the fixing member attachment portion and held by the fixing member. The light source attachment portion may extend from the heat dissipation portion in the overlapping direction of the display panel and the light guide plate. The light source attachment portion may be in contact with inner surfaces of the outer peripheral portions of the holding portions facing to each other. In this configuration, the light source attachment portion of the light source attachment member is in contact with the respective inner surfaces of the outer peripheral portions of the holding members that face to each other. Therefore, strength of the holding members further improves. In addition, heat generated by the light source is transferred to the other of the holding portions and the fixing member attachment portion via the light source attachment portion and the heat dissipation portion. Thus heat can be released.

(12) The display device may further include a flexible board and a printed circuit board. The flexible board may be connected to an end of the display panel. The printed circuit board may be connected to an end of the flexible board on a side opposite to a side closer to the display panel. The light source attachment member may include a heat dissipation portion and a light source attachment portion. The heat dissipation portion may extend along the surface of the outer peripheral portion of the other one of the holding portions. The heat dissipation portion may be sandwiched between the outer peripheral portion of the other one of the holding portions and the fixing member attachment portion and held by the fixing member. The light source attachment portion may extend from the heat dissipation portion in the overlapping direction of the display panel and the light guide plate. The light source may be attached to the light source attachment portion. The light source attachment portion may be arranged with a board space between the light source attachment portion and the fixing member attachment portion. The board space may be configured to house the printed circuit board therein. With this configuration, the printed circuit board connected to the flexible board can be arranged in the board space that is provided between the light source attachment portion and the fixing member attachment portion. In addition, heat generated from the lightened light source is transferred to the other of the holding portions and the fixing member attachment portion via the light source attachment portion and the heat dissipation portion. Thus heat can be released.

(13) One of the holding portions arranged on the display surface side may further include a light guide plate holding portion that is in contact with a surface of the light guide plate on the display surface side. In this configuration, the light guide plate holding portion holds the light guide plate from the display panel side. Therefore, the light guide plate can be held in a more stable condition, and the positional relationship between the light guide plate and the light source can be more stabilized.

### Advantageous Effect of the Invention

According to the present invention, strength is improved and display quality is increased.

### BRIEF DESCRIPTION OF THE DRAWINGS

FIG. 1 is an exploded perspective view of a general configuration of a television device and a liquid crystal display device according to a first embodiment of the present invention.

FIG. 2 is a rear view of the television device and the liquid crystal display device.

FIG. 3 is an exploded perspective view of a general configuration of a liquid crystal display unit of the liquid crystal display device.

FIG. 4 is a cross-sectional view of the liquid crystal display device taken along a short-side direction thereof.

FIG. 5 is a cross-sectional view of the liquid crystal display device taken along a long-side direction thereof.

FIG. 6 is a magnified cross-sectional view of the liquid crystal display device with a flexible board (and a common screw hole) cut along the short-side direction of the liquid crystal display device.

FIG. 7 is a magnified cross-sectional view of a light guide plate holding portion (and a screw hole for heat dissipation member) taken along the short-side direction of the liquid crystal display device.

FIG. 8 is a magnified cross-sectional view of FIG. 5.

FIG. 9 is a rear view of a frame.

FIG. 10 is a magnified rear view around a corner of the frame.

FIG. 11 is a cross-sectional view of the liquid crystal display device taken along the short-side direction thereof, illustrating assembling processes of components of the liquid crystal display unit included in the liquid crystal display device.

FIG. 12 is a cross-sectional view of the liquid crystal display device taken along the long-side direction thereof, illustrating assembling processes of the components of the liquid crystal display unit included in the liquid crystal display device.

FIG. 13 is a cross-sectional view of a screw attachment portion and a frame according to a second embodiment of the present invention.

FIG. 14 is a cross-sectional view of a liquid crystal display device according to a third embodiment of the present invention taken along a long-side direction thereof.

FIG. 15 is a cross-sectional view of the liquid crystal display device taken along a short-side direction thereof.

FIG. 16 is a cross-sectional view of a screw attachment portion and a frame according to a fourth embodiment of the present invention.

FIG. 17 is a cross-sectional view of a screw attachment portion and a frame according to a fifth embodiment of the present invention.

FIG. 18 is a cross-sectional view of a screw attachment portion and a frame according to a sixth embodiment of the present invention.

### MODE FOR CARRYING OUT THE INVENTION

### First Embodiment

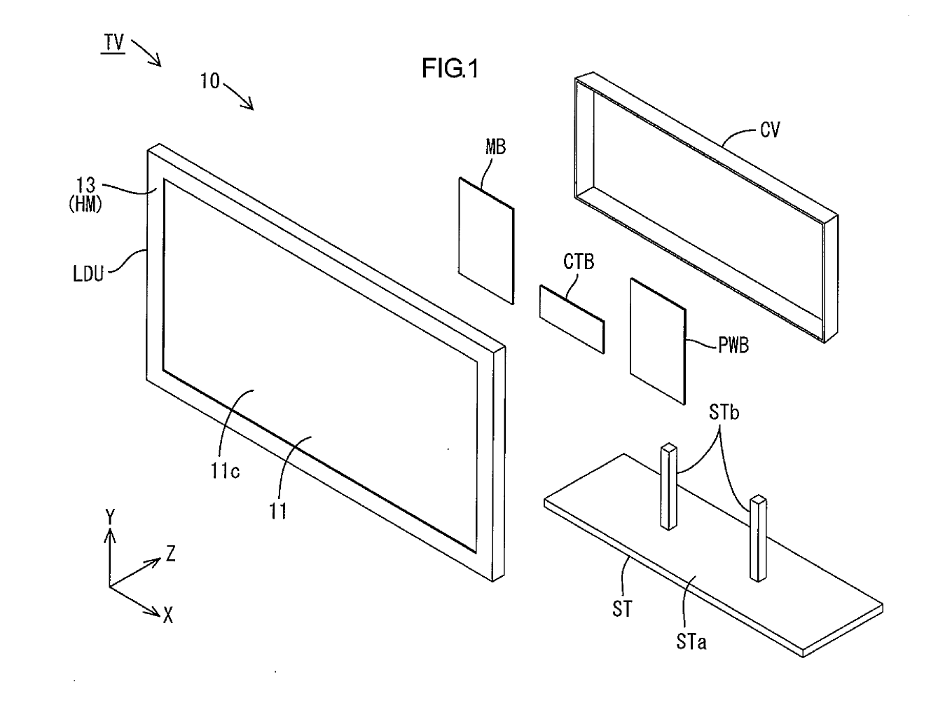

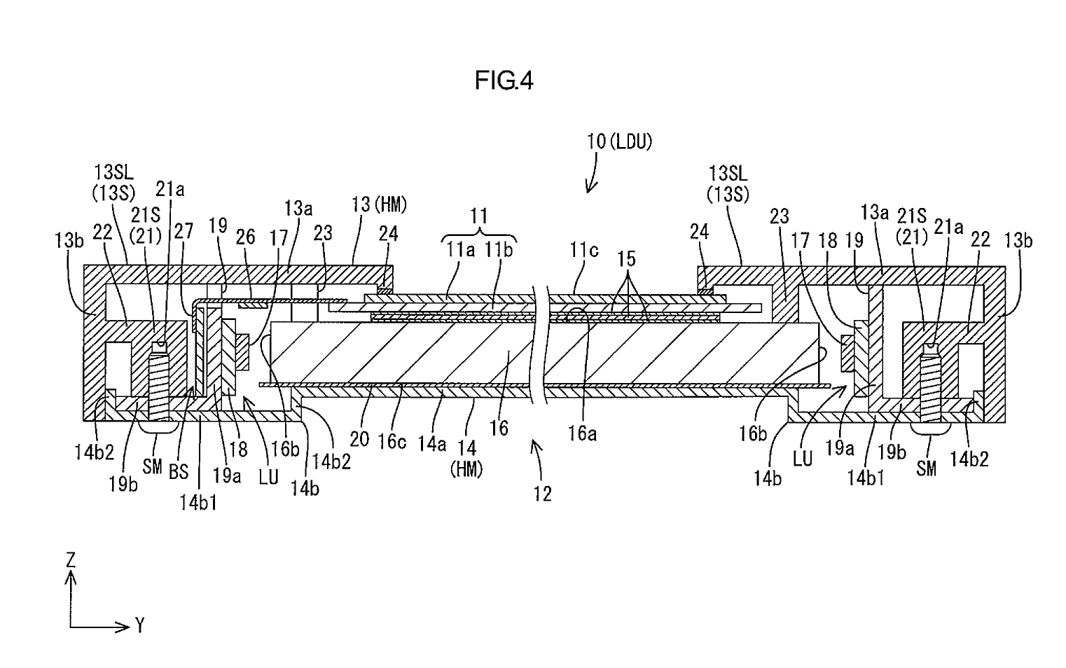

A first embodiment of the present invention will be described with reference to FIGS. 1 to 12. According to this embodiment, a liquid crystal display device 10 will be described. X-axis, Y-axis and Z-axis are indicated in some drawings. The axes in each drawing correspond to the respective axes in other drawings. The upper side and the lower side in FIG. 4 correspond to a front side and a rear side, respectively.

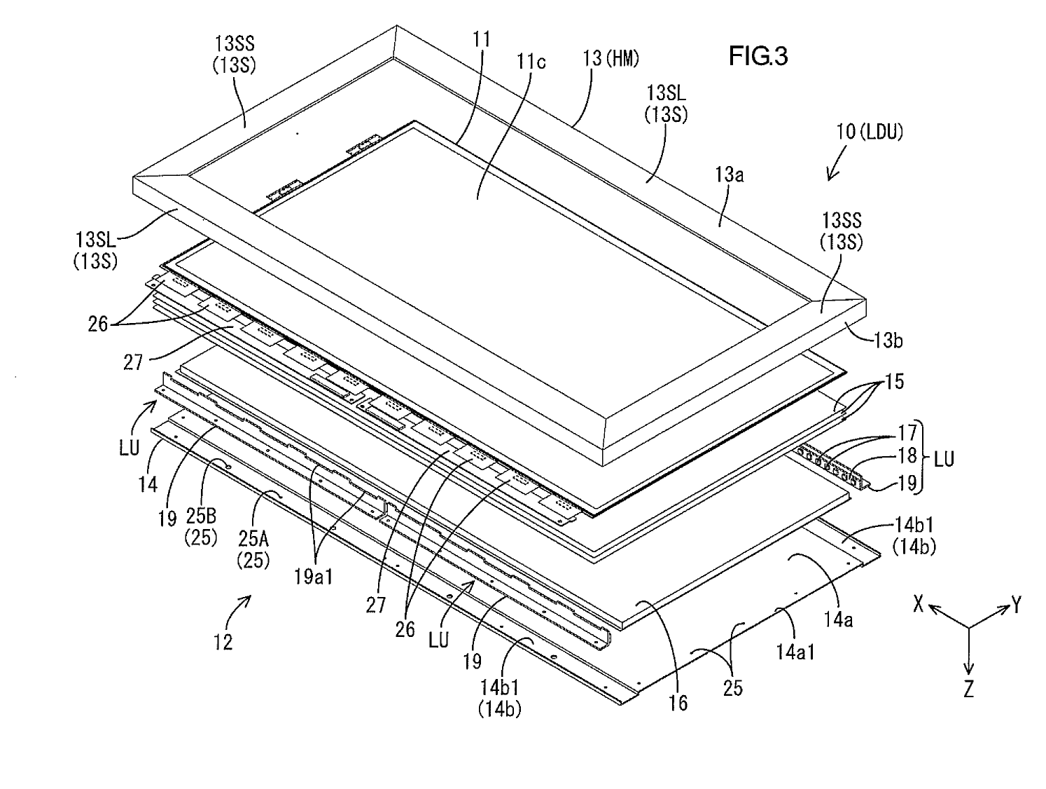

As illustrated in FIG. 1, a television device TV according to this embodiment includes a liquid crystal display unit LDU, boards PWB, MB, and CTB, a cover CV, and a stand ST. The boards PWB, MB, and CTB are attached on a rear surface (a back surface) of the liquid crystal display unit LDU. The cover CV is attached on a rear surface side of the liquid crystal display device 10 so as to cover the boards PWB, MB, and CTB. The stand ST supports the liquid crystal display unit LDU such that a display surface of the liquid crystal display unit LDU is aligned with the vertical direction (the Y-axis direction). The liquid crystal display device 10 according to this embodiment has the same configuration as the television device TV except for at least a component (e.g. a tuner included in the main board MB) for receiving television signals, which is not included in the liquid crystal display device 10. As illustrated in FIG. 3, the liquid crystal display unit LDU has a landscape rectangular shape (rectangular and longitudinal) as a whole. The liquid crystal display unit LDU includes a liquid crystal panel 11 as a display panel and a backlight unit (a lighting device) 12. The liquid crystal display device 10 includes a frame 13 and a chassis 14 as exterior members that provide an appearance thereof. The frame 13 will be referred to as a holding portion arranged on a display surface 11c side or one of the holding portions. The chassis 14 will be referred to as a holding member arranged on a side opposite from the display surface 11c or another one of the holding portions. The frame 13 and the chassis 14 hold the liquid crystal panel 11 and the backlight unit 12 therebetween. In other words, the frame 13 and the chassis 14 constitute a holding member HM. The chassis 14 according to this embodiment constitutes not only the exterior member and a part of the holding member HM but also a part of the backlight unit 12.

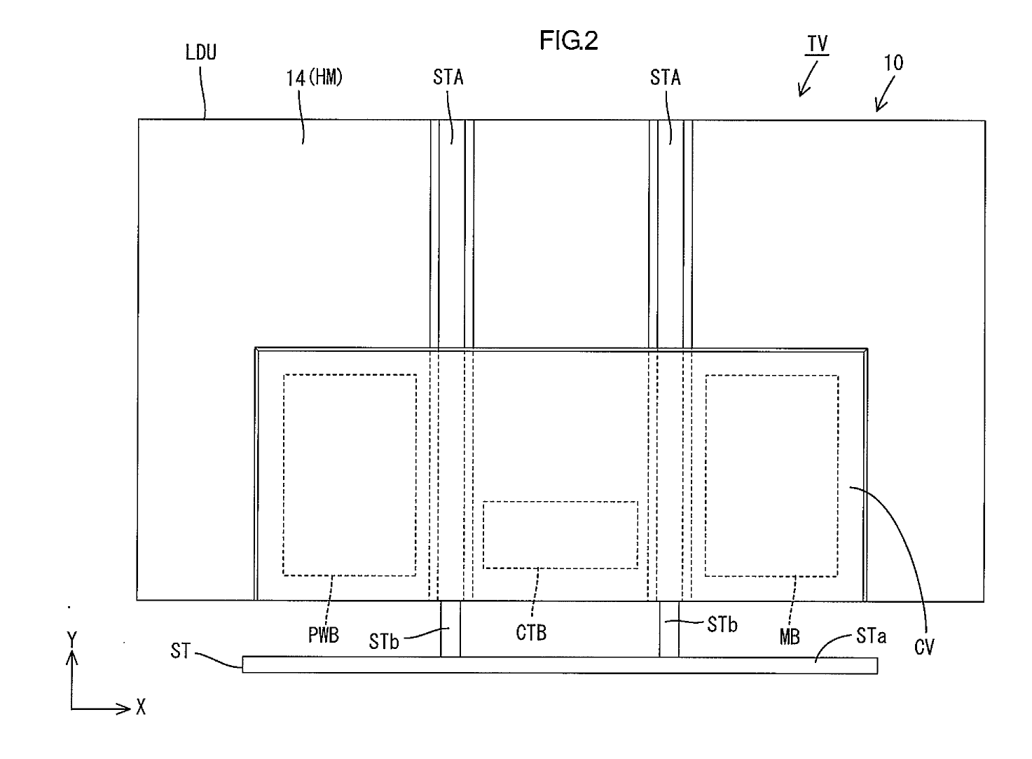

Configurations of the rear surface side of the liquid crystal display device 10 will be described. As illustrated in FIG. 2, stand fitting members STA are attached to a rear surface of the chassis 14. The rear surface of the chassis 14 provides a rear appearance of the liquid crystal display device 10. The stand fitting members STA are located apart from each other in the X-axis direction and extend along the Y-axis direction on the chassis 14. Each stand fitting member STA has a substantially channel-shaped cross section and is open to the chassis 14. A space is provided between stand fitting member STA and the chassis 14. Support portions STb included in the stand ST are inserted in the respective stand fitting members STA. The space provided in the stand fitting member STA is configured to be a path through which wiring members (e.g. electric wires) that are connected to LED boards 18 are passed. The LED boards 18 are included in the backlight unit 12. A base STa and the support portions STb constitute the stand ST. The base STa extends parallel to the X-Z plane. The support portions STb stand on the base STa in the Y-axis direction. The cover CV is made of synthetic resin and attached to a part of the rear surface of the chassis 14. Specifically, as illustrated in FIG. 2, the cover CV covers a lower half part of the chassis 14 so as to cross over the stand fitting members STA in the X-axis direction. A component storage space is provided between the cover CV and the chassis 14 such that the boards PWB, MB, and CTB, which will be described next, are stored therein.

AS illustrated in FIG. 2, the boards PWB, MB, and CTB are a power source board PWB, a main board MB, and a control board CTB. The power source board PWB will be referred to as a power supply source of the liquid crystal display device 10 and thus supplies drive power to the other boards MB and CTB and to LEDs 17 of in the backlight unit 12. In other words, the power source board PWB will also be referred to as “an LED drive board (a light source driving board) that drives the LEDs 17.” The main board MB includes at least a tuner and an image processor, which are not illustrated. The tuner is configured to receive television signals. The image processor performs image processing on the received television signals. The main board MB is configured to output the processed image signals to the control board CTB, which will be described next. If an external image reproducing device, which is not illustrated, is connected to the liquid crystal display device 10, image signals from the image reproducing device are input to the main board MB. The image processor included in the main board MB processes the image signals, and the main board MB outputs the processed image signals to the control board CTB. The control board CTB is configured to convert the image signals, which is sent from the main board MB, to driving signals for liquid crystals and to supply the driving signals to the liquid crystal panel 11.

As illustrated in FIG. 3, main components of the liquid crystal display unit LDU included in the liquid crystal display device 10 are arranged within a space provided between the frame (a front frame) 13, which constitutes a front appearance, and the chassis (a rear chassis) 14, which constitutes a rear appearance. The main components housed in the frame 13 and the chassis 14 are at least the liquid crystal panel 11, optical members 15, a light guide plate 16, and LED units (light source units) LU. The liquid crystal panel 11, the optical members 15, and the light guide plate 16 are placed on top of one another and held between the front frame 13 and the rear chassis 14. The optical members 15, the light guide plate 16, the LED units LU, and the chassis 14 constitute the backlight unit 12. In other words, the liquid crystal display unit LDU without the liquid crystal panel 11 and the frame 13 is the backlight unit 12. The LED units LU in the backlight unit 12 are arranged along long-side ends (the X-axis direction) of the light guide plate 16 in the frame 13 and the chassis 14. Specifically, two pairs of the LED units LU, four in total, sandwich the light guide plate 16 from both ends in a short-side direction (the Y-axis direction) of the light guide plate 16. Each LED unit LU includes LEDs 17 as light sources, the LED board (light source board) 18, and a heat dissipation member (a heat spreader, a light source attachment portion) 19. The LEDs 17 are mounted on the LED board 18. The LED board 18 is attached to the heat dissipation member 19. Each component will be described next.

As illustrated in FIG. 3, the liquid crystal panel 11 has a landscape rectangular shape (rectangular and longitudinal) in a plan view and includes a pair of glass substrates 11a and 11b and liquid crystals. The substrates 11a and 11b each having high light transmissivity are bonded together with a predetermined gap therebetween. The liquid crystals are sealed between the substrates 11a and 11b. One of the substrates 11a and 11b on the front side is a CF substrate 11a and the other one of the substrates 11a and 11b on the rear side (on the backside) is an array substrate 11b. On the array substrate 11b, switching elements (e.g. TFTs), pixel electrodes, and an alignment film are arranged. The switching elements are connected to gate lines and source lines that are arranged perpendicular to each other. The pixel electrodes are connected to the switching elements. On the CF substrate 11a, color filters, a counter electrode, and an alignment film are arranged. The color filters include red (R), green (G), and blue (B) color portions that are arranged in a predetermined arrangement. Polarizing plates, which are not illustrated, are arranged on outer sides of the substrates 11a and 11b.

As illustrated in FIG. 4, the array substrate 11b has a larger size than the CF substrate 11a in a plan view and is arranged such that ends of the array substrate 11b are located outer than the CF substrate 11a. Terminals extended from the gate lines and the source lines are provided in one of long-side ends in the array substrate 11b. The one of the long-side ends in the array substrate 11b is a side closer to the control board CTB than the other long-side end thereof in the Y-axis direction (the left end in FIG. 4). As illustrated in FIGS. 2 and 4, flexible boards (FPC boards) 26 are connected to the respective terminals. Each flexible board 26 includes a driver DR for controlling liquid crystals. The flexible boards 26 are arranged at intervals in the X-axis direction, that is, a direction along the long-side end of the array substrate 11b. Each flexible board 26 protrudes to the outside from the long-side end of the array substrate 11b in the Y-axis direction. The flexible board 26 includes a film-like base and wiring patterns (not illustrated) on the film-like base. The film-like base is made of synthetic resins that have insulation property and flexibility such as polyimide resins. The wiring patterns are connected to the driver DR mounted on about the center of the base. One end of each flexible board 26 is press-connected to each terminal of the array substrate 11b via an anisotropic conductive film (ACF). Another end of each flexible board 26 is press-connected to each terminal of a printed circuit board 27 via another anisotropic conductive film. The printed circuit board 27 will be described later. The printed circuit board 27 is connected to the control board CTB via a wiring member, which is not illustrated, and configured to transmit signals from the control board CTB to the flexible boards 26. The liquid crystal panel 11 thus displays images on the display surface 11c according to the signals from the control board CTB.

As illustrated in FIG. 4, the liquid crystal panel 11 is placed on a front side (a light exit side) of the optical members 15. A rear-side surface of the liquid crystal panel 11 (an outer-side surface of the polarizing plate on the rear side) is fitted to the optical member 15 with minimal gaps therebetween. Therefore, dust is less likely to enter between the liquid crystal panel 11 and the optical member 15. The display surface 11c in the liquid crystal panel 11 includes a display area and a non-display area. The display area is an inner area of a screen in which images are displayed. The non-display area is an outer area of the screen around the display area with a frame-like shape. The terminals and flexible boards 26 described earlier are arranged in the non-display area.

As illustrated in FIG. 3, each optical member 15 has a landscape rectangular shape in an plan view similar to the liquid crystal panel 11 and has about the same size (short-side dimension and long-side dimension) as the liquid crystal panel 11. The optical members 15 are placed on the front side (the light exit side) of the light guide plate 16 and sandwiched between the light guide plate 16 and the liquid crystal panel 11. Three optical members 15, each having a sheet-like shape, are placed on top of one another. Each optical member 15 may be selected from a diffuser sheet, a lens sheet, and a reflecting type polarizing sheet, whatever is appropriate.

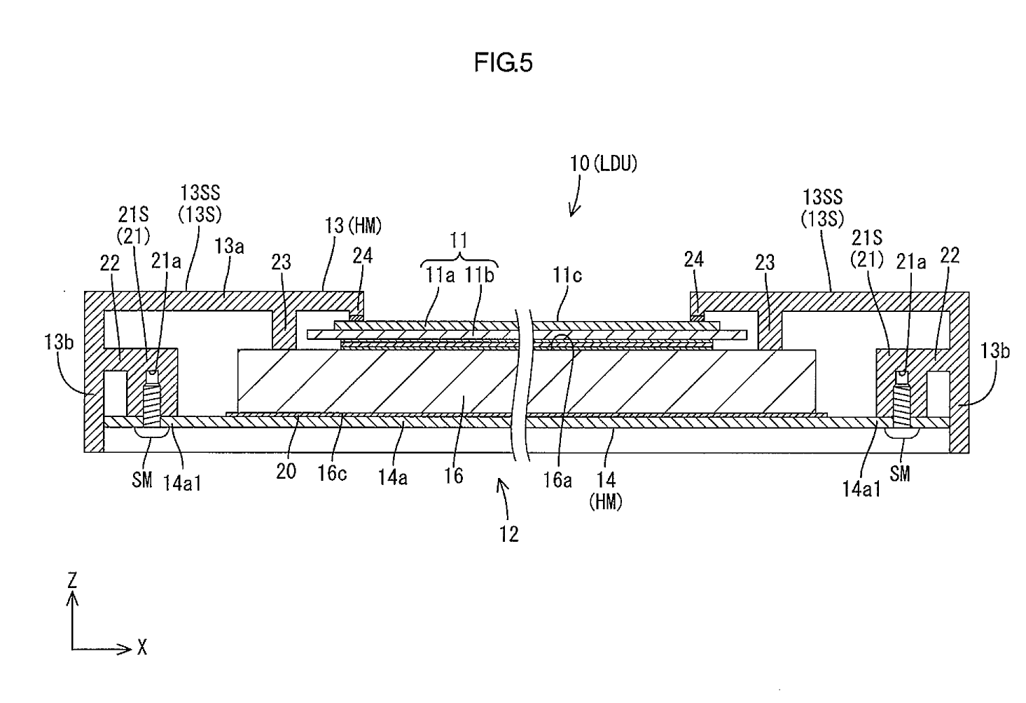

The light guide plate 16 is made of a substantially transparent (high transmissivity) synthetic resin (e.g. acrylic resin or polycarbonate such as PMMA) which has a refractive index sufficiently higher than that of the air. As illustrated in FIG. 3, the light guide plate 16 has a landscape rectangular shape in a plan view similar to the liquid crystal panel 11 and the optical members 15. A thickness of the light guide plate 16 is larger than a total thickness of the optical members 15. A long-side direction and a short-side direction of the main surface of the light guide plate 16 correspond to the X-axis direction and the Y-axis direction, respectively. A thickness direction of the light guide plate 16 that is perpendicular to the main surface corresponds to the Z-axis direction. The light guide plate 16 is arranged on the rear side of the optical members 15 and sandwiched between the optical members 15 and the chassis 14. As illustrated in FIG. 4, at least a short-side dimension of the light guide plate 16 is larger than short-side dimensions of the liquid crystal panel 11 and the optical members 15. The light guide plate 16 is arranged such that ends thereof in the short-side direction (ends along the long-side direction) are located outer (so as not to overlap each other in a plan view) than the ends of the liquid crystal panel 11 and the optical members 15. The LED units LU in each pair are arranged on opposite ends of the light guide plate 16 in the short-side direction. Light emitted from the LEDs 17 enters the light guide plate 16 from the ends in the short-side direction. The light guide plate 16 is configured to guide the light, which is emitted from the LEDs 17 and entered from the ends of the light guide plate 16 in the short-side direction, to the optical member 15 (on the front side). As illustrated in FIG. 5, a long-side dimension of the light guide plate 16 is larger than long-side dimensions of the liquid crystal panel 11 and the optical members 15. The light guide plate 16 is arranged such that ends thereof in the long-side direction (ends along the short-side direction) are located outer (so as not to overlap each other in a plan view) than the ends of the liquid crystal panel 11 and the optical members 15.

As illustrated in FIG. 4, one of the main surfaces of the light guide plate 16 that faces the front (a surface facing the optical members 15) is a light exit surface 16a. Light exits from the light guide plate 16 through the light exit surface 16a toward the optical members 15 and the liquid crystal panel 11. Outer peripheral surfaces of the light guide plate 16 that are adjacent to the main surfaces thereof include elongated long-side surfaces (end surfaces in the short-side direction) that extend in the X-axis direction. The long-side surfaces are each opposite the LEDs 17 (the LED boards 18) with specified distances therefrom and serve as light entrance surfaces 16b through which light from LEDs 17 enters. The light entrance surfaces 16b are parallel to the X-Z plane (main surfaces of the LED boards 18) and substantially perpendicular to the light exit surface 16a. An arrangement direction of the LEDs 17 and the light entrance surfaces 16b is aligned with the Y-axis direction and parallel to the light exit surface 16a.

As illustrated in FIGS. 4 and 5, a light guide reflection sheet (a reflection member) 20 is arranged on a rear side of the light guide plate 16, that is, a surface 16c opposite the light exit surface 16a (a surface facing the chassis 14). Light that travels from the surface 16c toward the rear is reflected toward the front by the light guide reflection sheet 20. The light guide reflection sheet 20 is arranged to cover an entire area of the surface 16c. In other words, the light guide reflection sheet 20 is arranged between the chassis 14 and the light guide plate 16. The light guide reflection sheet 20 is made of synthetic resin with a surface in white having high light reflectivity. As illustrated in FIG. 4, the light guide reflection sheet 20 has a short-side dimension larger than the short-side dimension of the light guide plate 16. The light guide reflection sheet 20 is arranged such that ends in the short-side direction thereof protrude closer to the LEDs 17 than light entrance surfaces 16b of the light guide plate 16. With the protruded portions (the long-side ends) of the light guide reflection sheet 20, light that travels from the LEDs 17 toward the chassis 14 at an angle is effectively reflected toward the light entrance surfaces 16b of the light guide plate 16. At least one of the light exit surface 16a and the surface 16c opposite the light exit surface 16a of the light guide plate 16 has a reflection portion (not illustrated) or a scattering portion (not illustrated). The reflection portion is configured to reflect the light inside the light guide plate 16. The scattering portion (not illustrated) is configured to scatter the light inside the light guide plate 16. The reflection portion or the scattering portion may be formed by patterning so as to have a specified in-plane distribution. This configuration regulates the light from the light exit surface 16a to have an even in-plane distribution.

The LEDs 17, the LED board 18, and the heat dissipation member 19 included in the LED unit LU will be described. As illustrated in FIGS. 3 and 4, each LED 17 includes an LED chip arranged on a board fixed on the LED board 18 and sealed with resin. The LED chip mounted on the board has one main light emission wavelength. Specifically, the LED chip that emits light in a single color of blue is used. On the other hand, the resin that seals the LED chip contains phosphors dispersed therein. The phosphors emit light in a predetermined color when excited by blue light emitted from the LED chip. Overall color of light emitted from the LED 17 is white. The phosphors may be selected, as appropriate, from yellow phosphors that emit yellow light, green phosphors that emit green light, and red phosphors that emit red light. The phosphors may be used in combination of the above phosphors. The LED 17 includes a main light-emitting-surface 17a that is opposite to a surface on which the LED board 18 is mounted (a surface opposite the light entrance surfaces 16b of the light guide plate 16). Namely, the LED 17 is a top-surface-emitting type LED.

As illustrated in FIGS. 3 and 4, each LED board 18 included in the LED unit LU has an elongated plate-like shape and extends in the long-side direction of the light guide plate 16 (the X-axis direction, the long-side direction of the light entrance surface 16b). The LED boards 18 are housed in the frame 13 and the chassis 14 such that a main board surface of each LED board 18 is parallel to the X-Z plane, that is, parallel to the light entrance surface 16b of the light guide plate 16. Each LED board 18 has a long-side dimension that is about a half of the long-side dimension of the light guide plate 16. The LED board includes a mount surface 18a on which the LEDs 17 are surface-mounted. The mount surface 18a is a main board surface facing an inner side, that is, a surface of the LED board 18 facing the light guide plate 16 (the opposite surface to the light guide plate 16). The LEDs 17 are arranged in line (i.e., linearly) at intervals on the mount surface 18a of the LED board 18 along the long-side direction of the LED board 18 (the X-axis direction). In other words, multiple LEDs 17 are arranged apart from each other in the long-side portions of the backlight unit 12 in the long-side direction. The LEDs 17 arranged in one of the long-side portions are parallel to the LEDs 17 arranged in the other one of the long-side portions. Distances between the adjacent LEDs 17 in the X-axis direction are substantially equal, that is, the intervals at which the LEDs 17 are arranged are substantially equal. An arrangement direction of the LEDs 17 is aligned with the longitudinal direction of the LED board 18 (the X-axis direction). Metal-film wiring patterns (not illustrated), such as copper-foil wiring patterns, are formed on the mount surface 18a of the LED board 18. The metal-film wiring patterns extend in the X-axis direction and cross over a group of the LEDs 17 so as to connect the adjacent LEDs 17 in series. Terminals at ends of the wiring patterns are electrically connected to the power source board PWB via wiring members including connecters and electric wires. Thus, driving power is supplied to the LEDs 17. The LED boards 18 arranged with the light guide plate 16 therebetween are housed in the frame 13 and the chassis 14 such that each mount surface 18a on which the LED 17s are mounted faces each other. Accordingly, the main light-emitting-surface 17a of each LED 17 faces each other. A light axis of each LED 17 is substantially aligned with the Y-axis direction. The substrate of each LED board 18 is made of metal, for instance, aluminum. Wiring patterns (not illustrated) are formed on the surface of the LED board 18 via an insulating layer. A material used for LED boards 18 may be an insulating material including ceramic.

As illustrated in FIGS. 3 and 4, the heat dissipation member 19 included in each LED unit LU is made of metal having high thermal conductivity, such as aluminum. The heat dissipation member 19 includes an LED attachment portion (light source attachment portion) 19a and a heat dissipation portion 19b. The LED board 18 is attached on the LED attachment portion 19a. The heat dissipation portion 19b is in plane-contact with a plate surface of the chassis 14. The LED attachment portion 19a and the heat dissipation portion 19b form an angle therebetween so as to have an L-like shape in a cross-section. The heat dissipation member 19 has a long-side dimension substantially equal to the long-side dimension of the LED board 18. The LED attachment portion 19a of the heat dissipation member 19 has a plate-like shape parallel to the plate surface of the LED board 18 and the light entrance surface 16b of the light guide plate 16. A long-side direction, a short-side direction, and a thickness direction of the LED attachment portion 19a are aligned with the X-axis direction, the Z-axis direction, and the Y-axis direction, respectively. The LED board 18 is mounted on an inner surface of the LED attachment portion 19a, that is, a plate surface that faces the light guide plate 16. While the LED attachment portion 19a has a long-side dimension that is substantially equal to the long-side dimension of the LED board 18, a short-side dimension of the LED attachment portion 19a is larger than a short-side dimension of the LED board 18. Therefore, ends of the LED attachment portion 19b in the short-side direction are located outer than the LED board 18 in the Z-axis direction. Screw attachment portions 21 included in the frame 13, which will be describes later, are located opposite plate surfaces of the LED attachment portions 19a on the outer side, that is, plate surfaces opposite from the surfaces on which the LED boards 18 are mounted. In other words, the LED attachment portion 19a is located between the screw attachment portion 21 of the frame 13 and the light guide plate 16. The LED attachment portion 19a rises from an inner end of the heat dissipation portion 19b, that is, an end of the heat dissipation portion 19b closer to the LEDs 17 (the light guide plate 16), toward the front side in the Z-axis direction (a direction in which the liquid crystal panel 11 and the light guide plate 16 overlap each other).

As illustrated in FIGS. 3 and 4, the heat dissipation portion 19b having a plate-like shape and is parallel to the plate surface of the chassis 14. A long-side direction, a short-side direction, and a thickness direction of the heat dissipation portion 19b are aligned with the X-axis direction, the Y-axis direction, and the Z-axis direction, respectively. The heat dissipation portion 19b extends from a rear-side end of the LED attachment portion 19a toward outside in the Y-axis direction. In other words, the heat dissipation portion 19b extends from an end closer to the chassis 14 toward a counter direction from the light guide plate 16. The heat dissipation portion 19b has a long-side dimension substantially equal to the long-side dimension of the LED attachment portion 19a. An entire rear plate surface of the heat dissipation portion 19b, that is, a plate surface of the heat dissipation portion 19b facing the chassis 14, is in contact with the plate surface of the chassis 14. A front plate surface of the heat dissipation portion 19b, that is, a plate surface opposite from the surface of the heat dissipation portion 19b in contact with the chassis 14, faces one of the screw attachment portions 21 of the frame 13. Specifically, the front plate surface of the heat dissipation portion 19b is in contact with a projected end surface of the screw attachment portion 21. The heat dissipation portion 19b is arranged so as to be sandwiched between the screw attachment portion 21 of the frame 13 and the chassis 14. With this configuration, heat generated by the lightened LEDs 17 is transferred to the LED board 18, the LED attachment portion 19a, and the heat dissipation portion 19b and then transferred to the chassis 14 and the screw attachment portion 21 of the frame 13. Therefore, heat is effectively released to the outside of the liquid crystal display device 10 and thus the heat is less likely to be stayed therein. The heat dissipation portion 19b includes a through hole 19b1 through which a screw member (fixing member) SM is passed. The heat dissipation portion 19b is fixed to the screw attachment portion 21 with the screw member SM.

Next, configurations of the frame 13 and the chassis 14 will be described. The frame 13 and the chassis 14 constitute the exterior member and the holding member HM. The frame 13 and the chassis 14 are made of metal such as aluminum so that mechanical strength (rigidity) and thermal conductivity are higher than those of the frame 13 and the chassis 14 made of synthetic resin. The liquid crystal display device 10 includes the LED units LU at the ends thereof in the short-side direction (the long-side end). The LED units LU on the one end correspond to the respective LED units LU on the other end. As illustrated in FIG. 3, the frame 13 and the chassis 14 hold the liquid crystal panel 11, the optical members 15, and the light guide plate 16 in layers from the front and rear side.

As illustrated in FIG. 3, the frame 13 has a landscape rectangular shape so as to surround the display area in the display surface 11c of the liquid crystal panel 11. The frame 13 includes panel holding portions 13a and sidewalls 13b. Each panel holding portion 13a is parallel to the display surface 11c of the liquid crystal panel 11. The panel holding portion 13a presses the liquid crystal panel 11 from the front side. Each sidewall 13b protrudes from an outer peripheral portion of each panel holding portion 13a toward the rear side. Each of the panel holding portion 13a and the sidewall 13b has an L-like shape in a cross-section. The panel holding portions 13a form a landscape-rectangular and frame-like shape as a whole that corresponds to an outer peripheral portion (the non-display area, the frame-like portion) of the liquid crystal panel 11. The panel holding portions 13a press a substantially entire area of the outer peripheral portion of the liquid crystal panel 11 from the front side. The panel holding portion 13a has a width that is large enough to cover not only the outer peripheral portion of the liquid crystal panel 11 but also the outer peripheral portions of the light guide plate 16 and the LED units LU from the front side. The outer peripheral portion of the light guide plate 16 and the outer peripheral portions of the LED units LU are located outside the outer peripheral portion of the liquid crystal panel 11 in the radiation direction. Similar to the display surface 11c of the liquid crystal panel 11, a front exterior surface (a surface opposite from the surface facing the liquid crystal panel 11) of each panel holding portion 13a is exposed to the outside from the front side of the liquid crystal display device 10. Namely, the panel holding portions 13a constitute a front exterior of the liquid crystal display device 10 together with the display surface 11c of the liquid crystal panel 11. Each sidewall 13b protrudes from the outer peripheral portion of each panel holding portion 13a toward the rear side. The sidewalls 13b form a substantially rectangular hollow shape as a whole. The adjacent sidewalls 13b surround whole peripheries of the liquid crystal panel 11, the optical members 15, the light guide plate 16, and the LED units LU as a whole. The adjacent sidewalls 13b also surround the whole periphery of the chassis 14 on the rear side as a whole. Outer surfaces of the sidewalls 13b that extend in a peripheral direction of the liquid crystal display device 10 are exposed to the outside of the liquid crystal display device 10. Therefore, the outer surfaces of the sidewalls 13b constitute a top surface, a bottom surface, and side surfaces of the liquid crystal display device 10.

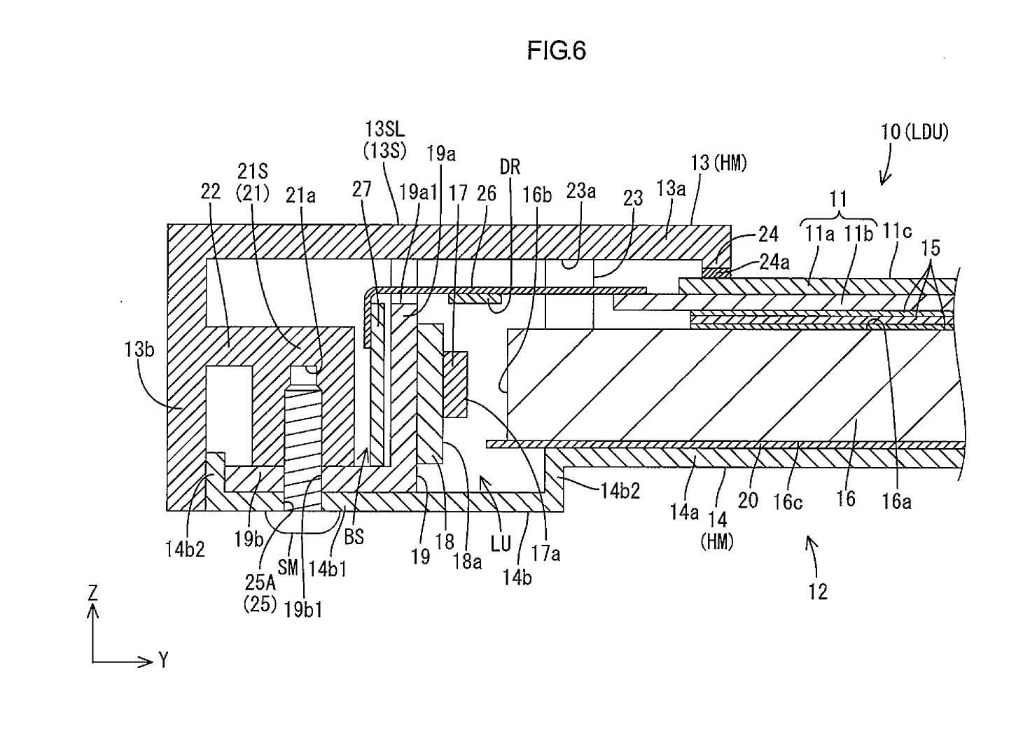

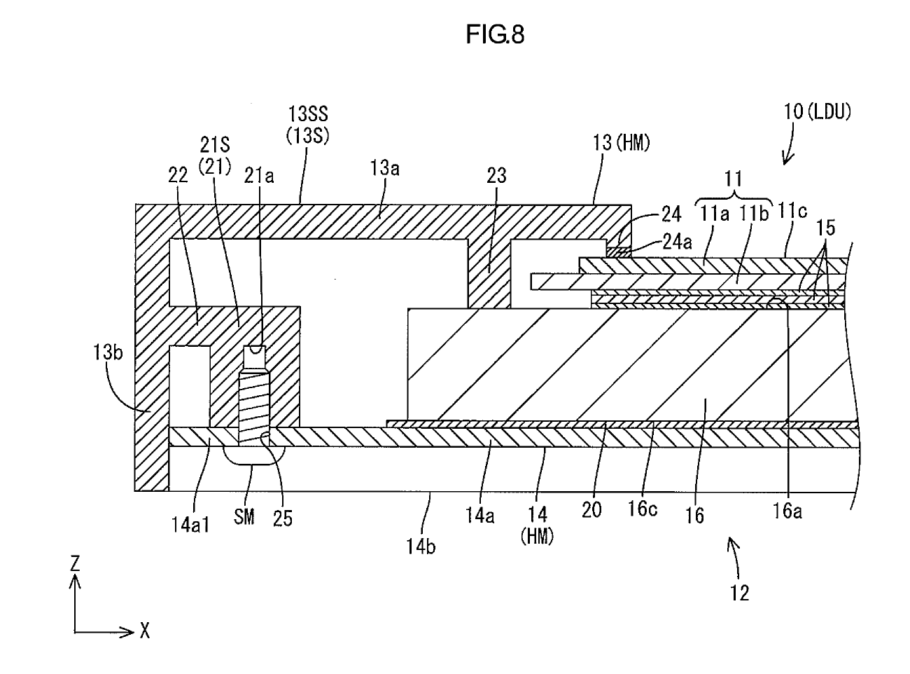

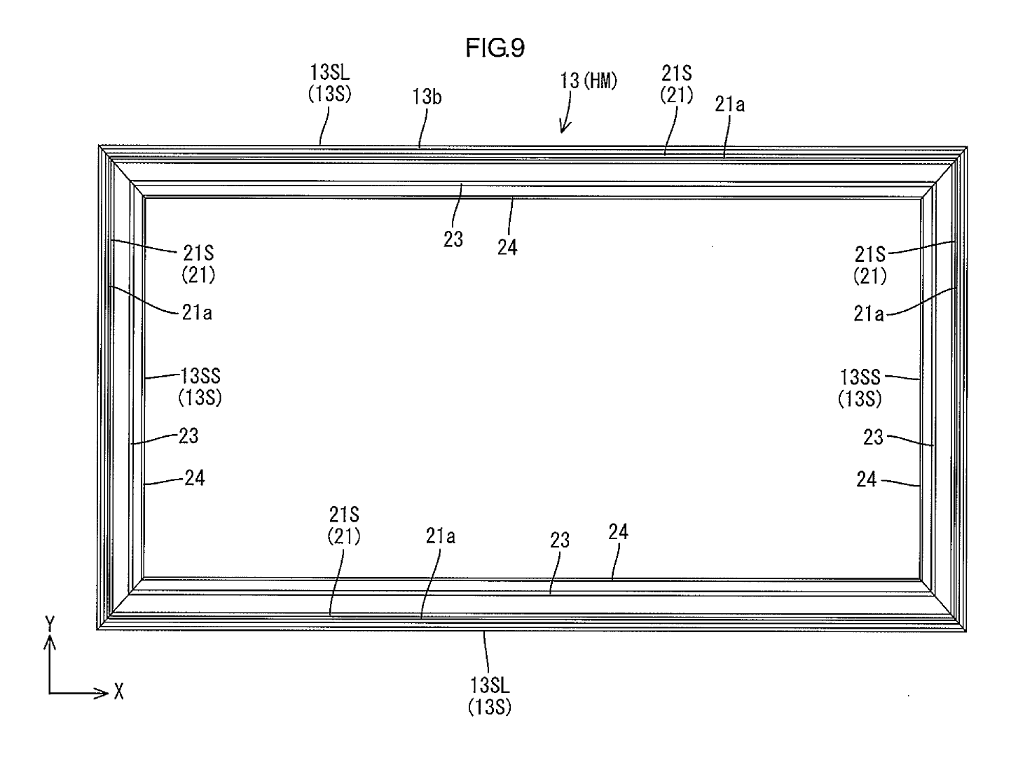

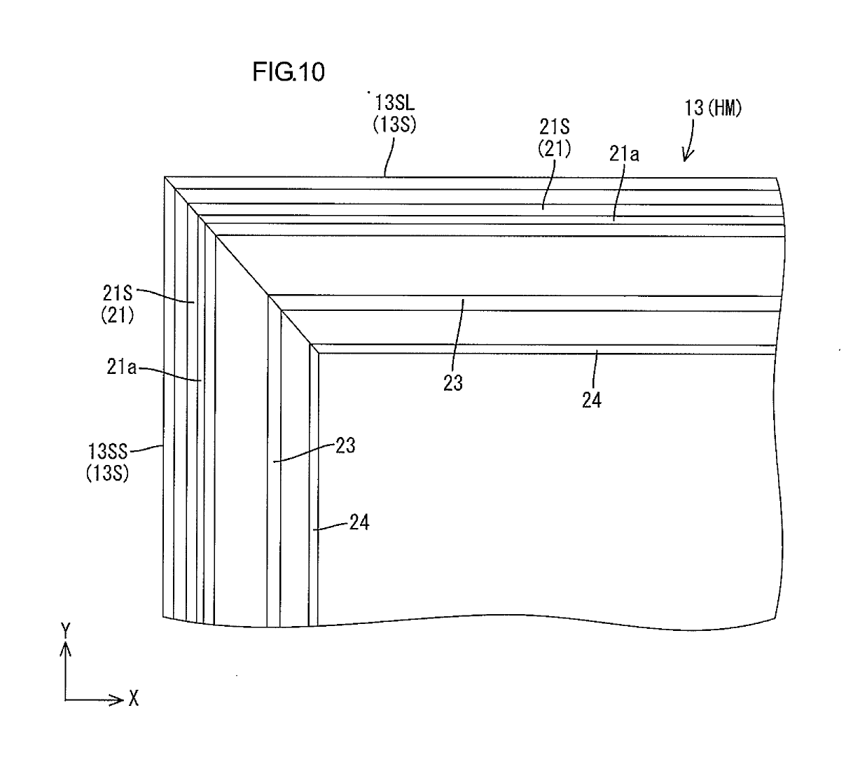

As illustrated in FIG. 9, the frame 13 formed in a frame-like shape with the above basic configuration includes four frame pieces 13S that are assembled together. Each frame piece 13S corresponds to each bar part of the frame 13 (long-side portions and shot-side portions). Specifically, the frame pieces 13S include long-side frame pieces 13SL and short-side frame pieces 13SS that constitute long-side portions and short-side portions of the frame 13 (the panel holding portions 13a and the sidewalls 13b), respectively. Each long-side frame piece 13SL is a rectangular block member whose cross section is an L-like shape. The long-side frame piece 13SL extends in the X-axis direction. Each short-side frame piece 13SS is a rectangular body member whose cross-section is an L-like shape. The short-side frame piece 13SS extends in the Y-axis direction. With this configuration, in production process, the frame pieces 13S can be formed by extruding metal material, for example. Thus, the production cost can be reduced compared to the frame 13 formed by cutting metal material. The long-side frame pieces 13SL and the adjacent short-side frame pieces 13SS form the frame 13 by jointing the respective edges thereof in the respective extending directions. As illustrated in FIGS. 9 and 10, the edges of the long-side frame pieces 13SL and the edges of the short-side frame pieces 13SS, which are the joint portions of the frame pieces 13SL and 13SS (joints in the frame 13), are angled against the X-axis and Y-axis directions in a plan view. Specifically, each edge is aligned with a straight line that passes through an outer edge and an inner edge of the corner portion in the panel holding portion 13a. The long-side frame piece 13SL (refer to FIG. 6) covers not only the liquid crystal panel 11, the optical members 15, and the light guide plate 16 but also the LED units LU. On the other hand, the short-side frame pieces 13SS (see FIG. 8) does not cover the LED units LU. Therefore, the long-side frame piece 13SL has a relatively larger width than the short-side frame pieces 13SS.

As illustrated in FIG. 3, the chassis 14 has a substantially longitudinal shallow tray shape as a whole and covers overall areas of the light guide plate 16 and the LED units LU from the rear side. A rear outer surface of the chassis 14 (a surface opposite from a surface that faces the light guide plate 16 and the LED units LU) is exposed to the rear side and constitutes a back surface of the liquid crystal display device 10. The chassis 14 includes a bottom plate portion 14a and LED housings (light source housings) 14b. The bottom plate portion 14a has a landscape rectangular shape similar to the light guide plate 16. Each LED housing 14b protrudes from long-side ends of the bottom plate portion 14a toward the rear side and forms a step. The LED units LU are arranged in the LED housing 14b.

As illustrated in FIGS. 3 and 4, the bottom plate portion 14a has a plane plate shape and thus can receive an inner area of the light guide plate 16 in the short-side direction (except the end portions in the short-side direction) from the rear side. In other words, the bottom plate portion 14a will be referred to as a light guide plate receiving portion. As illustrated in FIG. 5, end portions of the bottom plate portion 14a in the long-side direction extend outwardly from the end portions of the light guide plate 16 in the long-side direction. The end portions of the bottom plate portion 14a in the long-side direction are screw mount portions 14a1 in which the screw members (fixing members) SM are threaded. The screwed members SM hold the frame 13 and the chassis 14 in an assembled condition.

As illustrated in FIGS. 3 and 4, the LED housings 14b are arranged with the bottom plate portion 14a therebetween in the short-side direction. Each LED housing 14b is recessed toward the rear side from the bottom plate portion 14a, and thus the LED units LU can be arranged in the LED housings 14b. Each LED housing 14b includes a screw mount portion 14b1 and side plates 14b2. The screw mount portion 14b1 is arranged parallel to the bottom plate portion 14a. The screw members SM are attached therein from the outside. The side plates 14b2 rise from ends of the screw mount portion 14b1 toward the front side. One of the side plates 14b2 on the inner side continues to the bottom plate portion 14a. The inner surface of the screw mount portion 14b1 of the LED housing 14b is in contact with the heat dissipation portion 19b of the heat dissipation member 19 included in the LED unit LU.

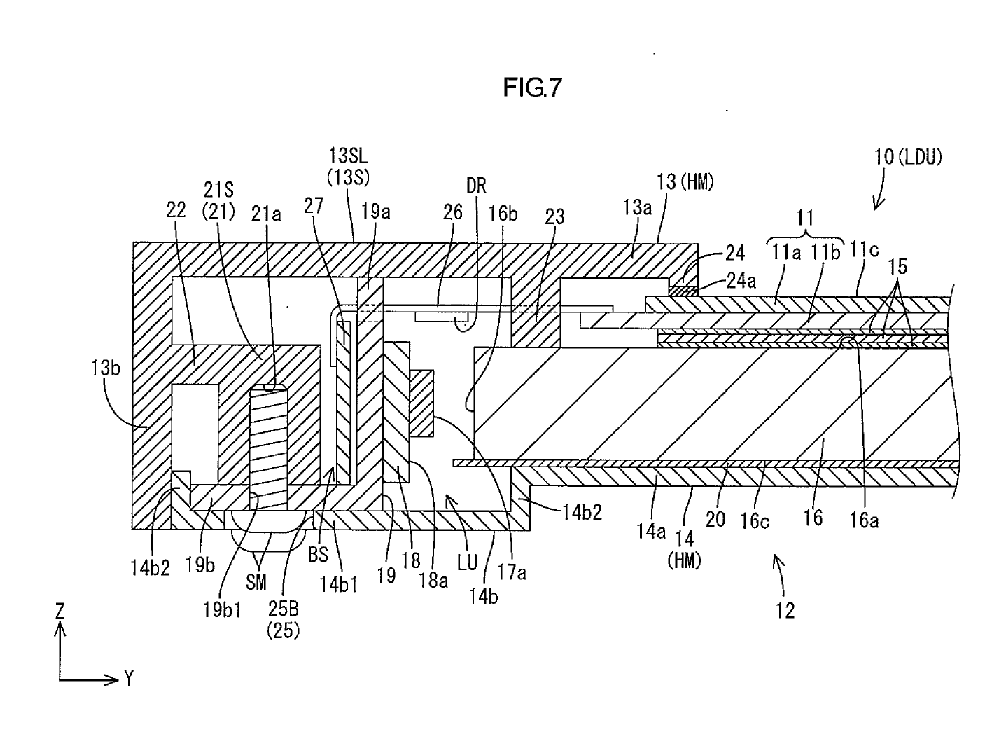

As illustrated in FIG. 3, the screw mount portions 14b1 of the LED housings 14b are arranged on the long-side ends in an outer peripheral portion of the chassis 14. The screw mount portions 14a1 of the bottom plate portion 14a are arranged on the short-side ends in the outer peripheral portion of the chassis 14. The screw mount portions 14a1 of the bottom plate portion 14a and the screw mount portions 14b1 of the LED housings 14b include screw through holes 25 through which the screw members SM are passed. The screw through holes 25 of the screw mount portion 14b1 that are in the LED housings 14b include common screw holes 25A and screw holes 25B for heat dissipation member. As illustrated in FIG. 6, only a body portion of the screw member SM passes through the common screw hole 25A. The screw member SM that is passed through the common screw hole 25A fixes the heat dissipation portion 19b and the housing bottom plate portion 14b1 to the screw attachment portion 21. As illustrated in FIG. 7, a head portion of the screw member SM in addition to the body portion thereof passes through the screw hole 25B for heat dissipation member. The screw member SM that is passed through the screw hole 25B fixes only the heat dissipation portion 19b to the screw attachment portion 21.

In the liquid crystal display device 10 according to the present embodiment, the liquid crystal panel 11, the optical members 15, and the light guide plate 16 are directly placed on top of one another. Unlike the conventional configuration, a panel receiving member is not provided between the liquid crystal panel and the light guide plate. Therefore, the overall strength of the liquid crystal display device 10 may be decreased by a strength that would have been provided by the panel receiving member. Furthermore, the positional relationship between the liquid crystal panel 11 and the light guide plate 16 in the Z-axis direction, which would have been maintained by the panel receiving member, may be unstable. Specifically, in the configuration in which the liquid crystal panel 11, the optical members 15, and the light guide plate 16 are directly placed on top of one another, the positional relationship among the members 11, 15, and 16 in the Z-axis direction depends on retention force applied to the members 11, 15, and 16. If the retention force is not sufficient or uneven, the members 11, 15, and 16 may be in tight-contact with one another in some parts of the surfaces but may not be in contact in other parts due to gaps caused thereamong. Consequently, amount of light supplied to the display surface 11c in the liquid crystal panel 11 may be uneven and thus the display quality of the displayed images may be decreased.

In the liquid crystal display device 10 according to the present embodiment, the screw attachment portions 21 are arranged along an outer peripheral portion of the frame 13. Each screw attachment portion 21 protrudes from each inner surface of the outer peripheral portion of the frame 13 and extends along each bar part thereof. With this configuration, the mechanical strength (rigidity) of the frame 13 is enhanced, and thus the frame 13 is less likely to be warped. Specifically, warping deformation along the each side portion (long-side frame pieces 13SL and short-side frame pieces 13SS) and twisting deformation about the axial line are less likely to occur. The liquid crystal panel 11, the optical members 15, and the light guide plate 16 are sandwiched between the frame 13 and the chassis 14 that are less likely to be warped. Therefore, high, even, and stable retention force is applied along the peripheral portions of the members 11, 15, and 16 and thus the liquid crystal panel 11, the optical members 15, and the light guide plate 16 remain in tight-contact together in substantially whole areas of the surfaces. As a result, amount of light supplied to the display surface 11c of the liquid display panel 11 is even in the surface area, and thus display quality of the image can be improved. The specific configuration of the screw attachment portions 21 will be described next.

As illustrated in FIGS. 4 and 5, each screw attachment portion 21 is formed into a single member with each sidewall 13b. The sidewalls 13b constitute the outer peripheral portion of the frame 13. The screw members SM are attached to the screw attachment portions 21 such that the screw mount portions 14a1 and 14b1 on the outer peripheral portion of the chassis 14 are sandwiched between the screw members SM and the screw attachment portions 21. The screw attachment portions 21 protrude inwardly from the inner surfaces of the sidewalls 13b (the X-axis direction or the Y-axis direction) so as to overlap the screw mount portions 14a1 and 14b1 of the chassis 14 in a plan view. Each screw attachment portion 21 is located between the panel holding portion 13a of the frame 13 and the chassis 14 in the Z-axis direction. The screw attachment portion 21 has an elongated block-like shape. The screw attachment portion 21 extends along each side of the sidewall 13b having a dimension equal to the length of each sidewall 13b. As illustrated in FIG. 9, the screw attachment portions 21 are frame pieces 13S included in the frame 13. When the frame pieces 13S are assembled together, the screw attachment portions 21 form a frame-like shape as a whole along the inner surfaces of the sidewalls 13b, which has the rectangular hollow shape in the assembled condition. In other words, the assembled screw attachment portions 21 having the frame-like shape include screw attachment pieces 21S that extend along the respective sides of the sidewalls 13b (the long-side portions and the short-side portions). The screw attachment pieces 21S form a frame-like shape as a whole if the adjacent screw attachment pieces 21S are connected to each other at respective edge surfaces in each extension direction. As illustrated in FIGS. 9 and 10, the edge surfaces of the adjacent screw attachment pieces 21S are angled against the X-axis and Y-axis directions in a plan view similar to the joint portions of the frame pieces 13S. Specifically, each edge is aligned with a straight line that passes through the outer edge and the inner edge of the corner portion in the panel holding portion 13a.

As illustrated in FIGS. 4 and 5, the screw attachment portions 21 include grooves 21a that are open to the rear side (the screw member SM side). The screw members SM are attached to the grooves 21a. Each groove 21a extends over the entire length of each screw attachment portion 21 in the longitudinal direction (see FIG. 9). A width dimension of the groove 21a is slightly smaller than that of the body portion of the screw member SM. As illustrated in FIG. 9, the screw attachment pieces 21S include the grooves 21a. The adjacent grooves 21a communicate with one another and form a frame shape in a plan view. As illustrated in FIGS. 4 and 5, rear surfaces of the screw attachment portions 21 in which the grooves 21a are formed are opposite the screw mount portions 14a1 and 14b1 of the chassis 14. The grooves 21a communicate with the screw through holes 25 of the screw mount portions 14a1 and 14b1. Each screw member SM is inserted in the screw through hole 25 from the rear side (the side opposite from the display surface 11c side) of the chassis 14 in the Z-axis direction (the overlapping direction of the liquid crystal panel 11 and the light guide plate 16) and fastened to the groove 21a in the screw attachment portion 21. If the screw member SM is fastened up, threads of the body portion of the screw member SM form thread grooves in the groove 21a. As illustrated in FIGS. 6 and 7, the rear surface of each screw attachment portion 21 on the long-side (the screw attachment pieces 21S on the long side) is in contact with the heat dissipation portion 19b of the heat dissipation member 19. The screw attachment portion 21 on the long-side and the head of the screw member SM that is passed through the common screw hole 25A hold the heat dissipation portion 19b and the screw mount portion 14b1 therebetween (see FIG. 6). The screw attachment portion 21 on the long-side and the head portion of the screw member SM that is passed through the screw hole 25B hold the heat dissipation portion 19b therebetween (see FIG. 7). As illustrated in FIG. 8, a rear surface of each screw attachment portion 21 on the short side (the screw attachment pieces 21S on the short-side) is in contact with the plate surface of each screw mount portion 14a1 on the short side. The screw attachment portion 21 on short-side and the head portions of the screw members SM that are passed through the screw through holes 25 hold the screw mount portion 14a1 on the short-side therebetween.

As illustrated in FIGS. 6 and 8, an outer surface of the screw attachment portion 21 opposite the sidewall 13b continues to a protrusion 22 that protrudes from the inner surface of the sidewall 13b. The screw attachment portion 21 is located more inside than the inner surface of the sidewall 13b with a predetermined space apart from the sidewall 13b. The protrusions 22 form a frame shape as a whole in a plan view. Each protrusion 22 extends along each inner surface of the sidewall 13b over its entire periphery. The protrusion 22 continues to the inner surface of the screw attachment portion 21 over its entire periphery. As illustrated in FIG. 6, a space is provided between the screw attachment portion 21 and the sidewall 13b on the long side by the size of the protrusion 22. The side plate 14b2 on the outer side of the LED housing 14b in the chassis 14 is arranged in the space, and thus the chassis 14 is properly positioned against the frame 13 in the Y-axis direction. In other words, the side plate 14b2 on the outer side of the LED housing 14b in the chassis 14 will be referred to as “a positioning portion.” The protrusion 22 continues to the front-side end of the screw attachment portion 21, that is, the screw attachment portion 21 projects from the protrusion 22 toward the rear side in the Z-axis direction.

As illustrated in FIGS. 6 and 8, the screw attachment portion 21 is arranged apart from the inner surface of the panel holding portion 13a with a predetermined space provided therebetween in the Z-axis direction. The screw attachment portion 21 and the panel holding portion 13a do not directly continue to each other. Therefore, heat generated by the lightened LEDs 17 is transferred from the LED board 18 to the heat dissipation member 19 and then transferred to the screw attachment portion 21 on the long side. The heat is then transferred to the sidewall 13b, which continues from the screw attachment portion 21, and the screw mount portion 14b1 of the chassis 14, which is in contact with the heat dissipation portion 19b. Because the heat hardly transfers to the panel holding portion 13a directly, the panel holding portion 13a is less likely to be increased in temperature compared to the sidewall 13b and the chassis 14. In this embodiment, the panel holding portion 13a constitutes the front side of the liquid crystal display device 10, that is, an appearance on the user side where an external object is more likely to touch. However, since the temperature increase is less likely to occur in the panel holding portion 13a, the object that touches the panel holding portion 13a is less likely to be affected by heat.

Since the space is provided between the screw attachment portion 21 and the panel holding portion 13a, the projection 21 does not directly support the panel holding portion 13a. However, as illustrated in FIGS. 6 and 7, the heat dissipation portion 19b of the heat dissipation member 19 is in contact with the inner surface of the screw mount portion 14b1 in the chassis 14. Furthermore, the LED attachment portion 19a that rises in the Z-axis direction is in contact with the inner surface of the screw mount portion 14b1 and the inner surface of the panel holding portion 13a of the frame 13. In other words, the LED attachment portion 19a is configured to be a support wall that supports the panel holding portion 13a of the frame 13 and the screw mount portion 14b1 of the chassis 14 that are parallel to each other. Therefore, retention of the frame 13 and the chassis 14 improves.

As illustrated in FIG. 4, the screw attachment portions 21 on each long side are arranged between the sidewalls 13b of the frame 13 and the LED attachment portions 19a of the heat dissipation members 19 of the LED units LU in the Y-axis direction. A predetermined space is provided between each screw attachment portion 21 and each LED attachment portion 19a. As illustrated in FIGS. 6 and 7, the space provided between the heat dissipation members 19 that overlap the flexible boards 26 in a plan view and the screw attachment portion 21 to which the above heat dissipation members 19 are mounted is a board space BS. The printed circuit board 27 can be arranged in the board space BS. In other words, the printed circuit board 27 is arranged between the screw attachment portion 21 and the LED attachment portion 19a. The printed circuit board 27 is made of synthetic resin and has a landscape rectangular shape. The printed circuit board 27 extends along the longitudinal direction (the X-axis direction) of the screw attachment portion 21 and the LED attachment portion 19a. The printed circuit board 27 is arranged in the board space BS such that a plate surface thereof is aligned with an outer plate surface (the opposite side from the LED board 18 side) of the LED attachment portion 19a. Specifically, a long-side direction, a short-side direction, and a width direction of the printed circuit board 27 are aligned with the X-axis direction, the Z-axis direction, and the Y-axis direction, respectively. The flexible boards 26 are arranged at intervals along the long-side direction of the printed circuit board 27. The other end portions are connected to each other. The flexible boards 26 that are connected to the printed circuit board 27 and the array board 11b of the liquid crystal panel 11 crossover the LED attachment portion 19a, the LED board 18, and the LEDs 17 in the Y-axis direction. The printed circuit board 27 includes a connecter (not illustrated) to which an end of an FPC (not illustrated) is connected. The other end of the FPC extends to the rear side of the chassis 14 through an FPC hole (not illustrated) in the chassis 14 and is connected to the control board CTB. Recesses 19a1 for flexible board are formed in the LED attachment portions 19a of the heat dissipation members 19 that overlaps the flexible boards 26 in a plan view. The recesses 19a1 for flexible board are aligned at intervals in a line in the X-axis direction. The arrangement in the recesses 19a1 for flexible board matches the arrangement in the flexible boards 26.

As illustrated in FIGS. 4 and 5, an inner peripheral edge of the panel holding portion 13a includes a holding protrusion 24 that protrudes toward the rear side, namely, the liquid crystal panel 11 side. The holding protrusion 24 includes a shock absorber 24a at the protruded end surface. The holding protrusion 24 presses the liquid crystal panel 11 from the front side through the shock absorber 24a. As illustrated in FIG. 9, similar to the screw attachment portions 21, the frame pieces 13S that constitute the frame 13 include the holding protrusions 24 and the shock absorbers, each of which extends along the side of each frame piece 13S. When the frame pieces 13S are assembled together, the holding protrusions 24 and the shock absorbers 24a form frame-like shapes as a whole along the inner peripheral surfaces of the panel holding portions 13a over the entire length.

As illustrated in FIGS. 4 and 5, the panel holding portions 13a include light guide plate holding portions 23 on the outer side of (a position closer to the LED unit LU) the holding protrusions 24. The light guide plate holding portions 23 hold the light guide plate 16 from the front side. Each light guide plate holding portion 23 protrudes from the inner surface of the panel holding portion 13a toward the rear side in the Z-axis direction. The light guide plate holding portion 23 has an elongated block-like shape. Each light guide plate holding portion 23 extends along the side of each panel holding portion 13a over the entire length. Similar to the screw attachment portion 21, as illustrated in FIG. 9, the frame pieces 13S of the frame 13 include the light guide plate holding portions 23. Each light guide plate holding portion 23 extends along the side of each frame piece 13S. When the frame pieces 13S are assembled together, the light guide plate holding portions 23 form a frame-like shape as a whole and extend along the entire length of the panel holding portions 13a (the light guide plate 16). As illustrated in FIGS. 4 and 5, the light guide plate holding portions 23 are arranged so as to overlap an outer peripheral end portion of the light guide plate 16. The outer peripheral end portion of the light guide plate 16 is located more outside than the liquid crystal panel 11 and the optical members 15. The extended end surfaces of the light guide plate holding portions 23 are in contact with a front surface of the outer peripheral end portion of the light guide plate 16. Therefore, the light guide plate holding portions 23 can hold the light guide plate 16 between with the chassis 14, which is described later. In other words, the light guide plate holding portions 23 have a light guide supporting function. The light guide plate 16 is pressed from the front side by the light guide plate holding portions 23 that form a frame shape as a whole and extend along the outer peripheral end portion of the light guide plate 16 over the entire length. The long-side ends of the light guide plate 16 that are in contact with the light guide plate holding portions 23 are the end portions of the light guide plate 16 that include the light entrance surfaces 16b through which light from LEDs 17 enters the light guide plate 16. With the configuration in which the light guide plate holding portions 23 hold the light guide plate 16, the positional relationship between the LEDs 17 and the light entrance surfaces 16b in the Z-axis direction can be maintained in a more stable condition.

As illustrated in FIG. 4, each light guide plate holding portion 23 on the long side included in each long-side frame piece 13SL extends along the panel holding portion 13a on the long side. The light guide plate holding portion 23 on the long side is arranged between the liquid crystal panel 11 and the LEDs 17. Specifically, the light guide plate holding portion 23 on the long side shuts the space that exists between the LEDs 17 and the respective end surfaces of the liquid crystal panel 11 and the optical members 15 on the LEDs 17 side. Therefore, light from the LEDs 17 is less likely to directly enter the above end surfaces of the liquid crystal panel 11 and the optical members 15 without passing through the light guide plate 16. In other words, the light guide plate holding portions 23 on the long side will be referred to as light blocking portions for blocking light. One of the light guide plate holding portions 23 on the long side that overlaps the flexible boards 26 in a plan view includes recesses 23a for flexible board. The recesses 23a for flexible board are formed in line at intervals in the X-axis direction. The arrangement in the recesses 23a for flexible board matches the arrangement in the flexible boards 26.

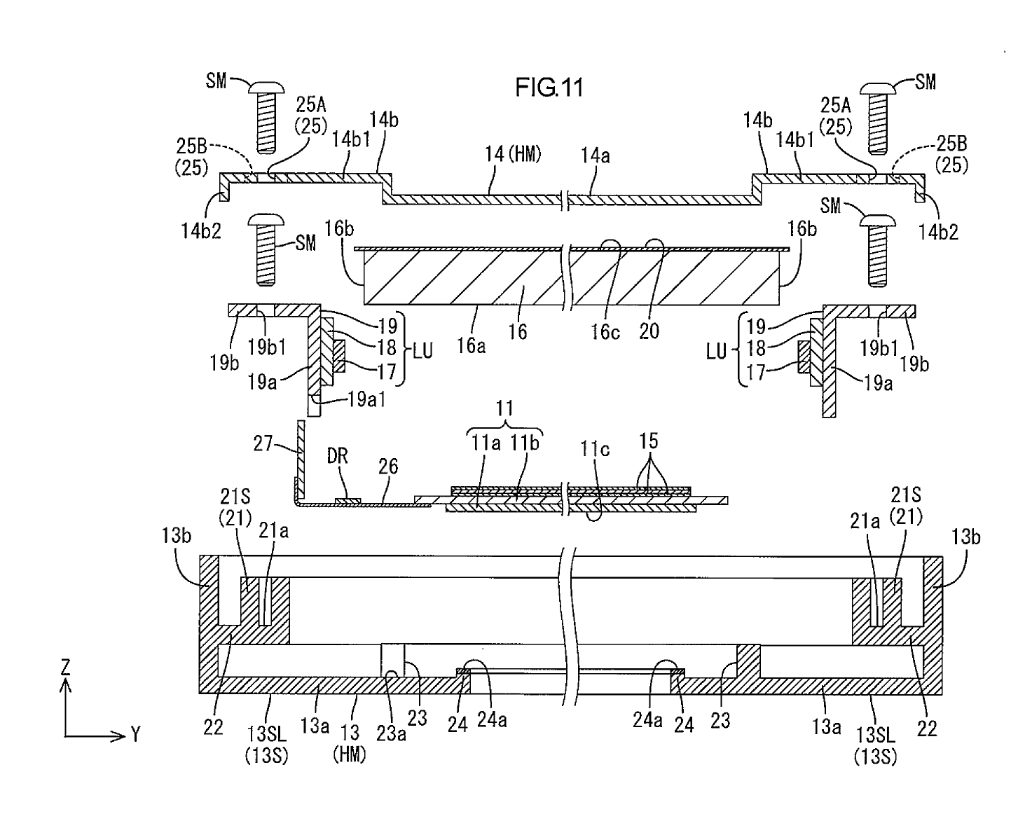

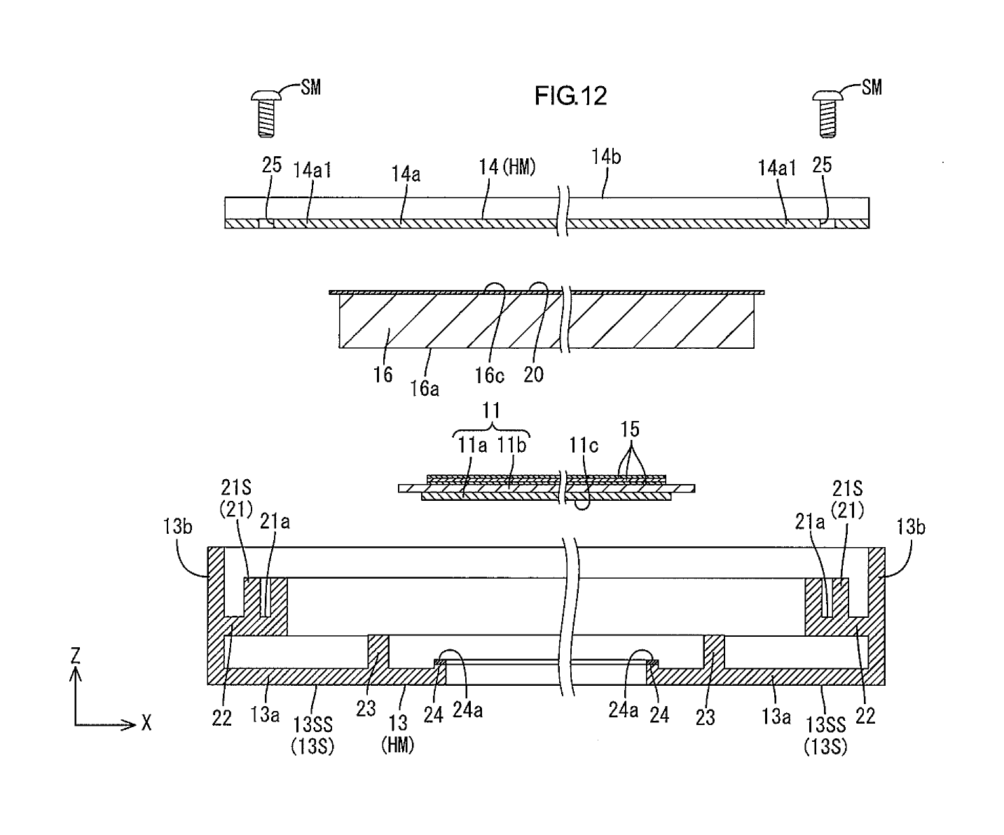

The present embodiment has the above-described structure, and an operation thereof will be described. The components (e.g. the frame 13, the chassis 14, the liquid crystal panel 11, the optical members 15, the light guide plate 16, and the LED units LU) are separately produced and assembled into the liquid crystal display device 10. All of the components are assembled with a state in which the upsides of FIGS. 4 and 5 are turned down in the Z-axis direction. As illustrated in FIGS. 11 and 12, the frame 13 is placed on a workbench (not illustrated) with the rear surface thereof facing the upside in the vertical direction. The frame 13 is formed into a frame shape in advance by jointing the four frame pieces 13S together.

As illustrated in FIG. 11, the flexible boards 26 and the printed circuit board 27 are connected to the liquid crystal panel 11 in advance. As illustrated in FIGS. 11 and 12, the liquid crystal panel 11 is then assembled to the frame 13 in the above state. The CF substrate 11a faces the upside in the vertical direction and the array substrate 11b faces the downside. The printed circuit board 27 is attached to the screw attachment portion 21 such that the plate surface of the printed circuit board 27 is aligned with a surface of the screw attachment portion 21 of the frame 13 on the liquid crystal panel 11 side. As a result, each flexible board 26 is bent into an L-like shape. In this attachment process, the flexible boards 26 are inserted in the respective recesses 23a that are in overlapping relations therewith in a plan view in the light guide plate holding portion 23. The flexible boards 26 thus can be positioned in the X-axis direction against the respective recesses 23a for flexible board. The liquid crystal panel 11 is placed on the shock absorber 24a attached on the holding protrusion 24 so that shocks are absorbed by the shock absorber 24a. The optical members 15 are then sequentially placed on the rear side of the liquid crystal panel 11.

As illustrated in FIG. 11, the LED unit LU including the LEDs 17, the LED boards 18, and the heat dissipation members 19 that are assembled in advance is mounted to the frame 13. Each LED unit LU is placed on each screw attachment portions 21 of the frame 13 such that the LEDs 17 face the center (inner side) of the frame 13 and the heat dissipation portion 19b of each heat dissipation member 19 faces the screw attachment portion 21 of the frame 16. A front-end surface of the LED attachment portion 19a of the heat dissipation member 19 is in contact with the inner surface of the panel holding portion 13a of the frame 13. In the LED unit LU and the screw attachment portion 21 in the assembled condition, the through holes 19b1 included in the heat dissipation portion 19b communicate with the groove 21a of the screw attachment portion 21. In the LED unit LU that is in an overlapping position with the flexible boards 26 in a plan view, the recesses 19a1 for flexible board formed in the LED attachment portion 19a of the heat dissipation member 19 are positioned against the respective flexible boards 26 in the X-axis direction. The flexible boards 26 are then fitted in the respective recesses 19a1 for flexible board. When the above heat dissipation member 19 is attached to the screw attachment portion 21, the board space BS is provided between the LED attachment portion 19a and the screw attachment portion 21. The printed circuit board 27 is arranged in the board space BS.

After attaching the LED units LU to the screw attachment portion 21, as illustrated in FIG. 11, the screw members SM are passed through the predetermined through holes 19b1 in the heat dissipation portion 19b from the rear side and fastened in the groove 21a in the screw attachment portion 21. When the screw member SM is fastened up, the screw member SM is threaded forward in the Z-axis direction, that is, an axial direction of the body portion in the screw member SM. The heat dissipation portion 19b of the heat dissipation member 19 is sandwiched between the head portions of the screw members SM and the screw attachment portion 21. The LED units LU are attached to the screw attachment portion 21 in advance to assemble the chassis 14, which will be described next (see FIG. 7). The LED units LU may be assembled to the frame 13 before assembling of the optical members 15 or before assembling of the liquid crystal panel 11 to the frame 13.

After the LED units LU are fixed to the screw attachment portion 21 with screws, as illustrated in FIGS. 11 and 12, the light guide plate 16 is directly placed on a surface of one of the optical member 15 on the most rear side. The light guide reflection sheet 20 is then directly placed on the opposite surface 16c of the light guide plate 16, which is the opposite surface from the light exit surface 16a. Herein, the long-side ends of the light guide plate 16 are held by the light guide plate supporting portions 23 from the lower side (the front side) in the vertical direction in the assembling process.

After the liquid crystal panel 11, the optical members 15, the light guide plate 16, and the LED units LU are assembled to the frame 13 as described above, the chassis 14 is to be assembled. As illustrated in FIGS. 11 and 12, the chassis 14 is attached to the frame 13 such that the front surface thereof faces downward in the vertical direction. The side plate 14b2 on the outer side of each LED housing 14b in the chassis 14 is inserted in each space provided between the sidewall 13b on the long side and the screw attachment portion 21 in the frame 13. The frame 13 is thus positioned against the chassis 14 in the Y-axis direction. In assembly process, the head portions of the screw members SM that are attached to the heat dissipation members 19 and the screw attachment portions 21 in advance pass through the screw holes 25B for heat dissipation member in the LED housings 14b of the chassis 14 (see FIG. 7). The bottom plate portion 14a of the chassis 14 comes into contact with the light guide plate 16 (the light guide reflection sheet 20). The screw mount portions 14a1 of bottom plate portion 14a come into contact with the screw attachment portions 21. The LED mount portion 14b1 of the LED housing 14b comes into contact with the heat dissipation member 19. After that, the screw members SM are inserted in the screw through holes 25 of the LED screw mount portions 14a1 of the bottom plate portion 14 and the common screw through holes 25A of the LED screw mount portions 14b1 of the LED housings 14b from the rear side. The screw members SM are then fastened in the groove 21a of the screw attachment portion 21. If the screw members SM are fastened up, the screw members SM are threaded forward in the Z-axis direction, that is, the axial direction of the body portion. The LED units LU and the chassis 14 are fixed to the screw attachment portions 21 by the screw members SM (see FIGS. 6 and 8). In this configuration, the screw members SM are arranged on the rear side of the chassis 14 and serves as a rear appearance of the liquid crystal display device 10. Therefore, the screw members SM are hardly recognized from the front side, that is, the side from which the user uses the liquid crystal display device 10, and thus the liquid crystal display device 10 can have a high-leveled design with a simplified appearance.

The assembly of the liquid crystal display unit LDU is complete as described above. After the stand fitting members STA and the boards PWB, MB, and CTB are attached to the rear side of the liquid crystal display unit LDU, the stand ST and the cover CV are attached thereto. Thus, the liquid crystal display device 10 and the television device TV are produced. The frame 13 that holds the liquid crystal panel 11 from the display surface 11c side and the chassis 14 that constitutes the backlight unit 12 constitute the appearance of the liquid crystal display device 10. The liquid crystal panel 11 and the optical members 15 are placed on top of one another directly. In the conventional liquid crystal display device 10, a cabinet or a panel receiving member is provided. The cabinet is made of synthetic resin and prepared different from the frame 13 and the chassis 14. The panel receiving member is arranged between the liquid crystal panel 11 and the optical members 15 to separate the liquid crystal panel 11 and the optical members 15. Compared to the conventional configuration, the production cost can be reduced because the numbers of components and assembling workability are reduced. Furthermore, the thickness and weight of the liquid crystal display device can be reduced.

As illustrated in FIG. 4, when the liquid crystal display device 10 produced as above is turned on, the power source board PWB starts to supply power. Followed by the power supply, the control board CTB sends signals to the liquid crystal panel 11 via the printed circuit board 27 and the flexible board 26 (driver DR) and controls driving of the liquid crystal panel 11. The LEDs 17 included in the backlight unit 12 are also driven. Light from each LED 17 is reflected by the light guide plate 16 toward the optical members 15. The light that has passed through the optical members 15 is a planar light having an even brightness and apply to the liquid crystal panel 11. As a result, predetermined images are displayed on the liquid crystal panel 11. Hereinafter, operations of the backlight unit 12 will be described. As illustrated in FIG. 6, when the LED 17 is turned on, light emitted from the LED 17 enters the light guide plate 16 from the light entrance surface 16b. The light in the light guide plate 16 from the light entrance surface 16b may be totally reflected at an interface of the light guide plate 16 with an outer air layer, or reflected by the light guide reflection sheet 20. The light thus passes throughout the light guide plate 16. The light is reflected and scattered by unillustrated reflection portions or scattering portions of the light guide plate 16 and exits the light guide plate 16 from the light exit surface 16a toward the optical members 15.

In the liquid crystal display device 10 according to the present embodiment, the liquid crystal panel 11 is directly placed on the optical members 15 and the light guide plate 16. Unlike the conventional liquid crystal display device, a panel receiving member is not provided between the liquid crystal panel 11 and the optical members 15 and the light guide plate 16. Therefore, the overall strength of the liquid crystal display device 10 may be decreased by a strength that would have been provided by the panel receiving member. Furthermore, the positional relationship between the liquid crystal panel 11 and the light guide plate 16 in the Z-axis direction, which would have been maintained by the panel receiving member, may be unstable. However, as illustrated in FIGS. 4 and 5, the screw attachment portions 21 are arranged on the outer peripheral portion of the frame 13 in the liquid crystal display device 10 according to the present embodiment. Since each screw attachment portion 21 protrudes from each inner surface of the outer peripheral portion of the frame 13 and extends along each side of the outer peripheral portion, mechanical strength (rigidity) of the frame 13 improves. Furthermore, the screw attachment portions 21 extend along the sides of the outer peripheral portion of the frame 13 over its entire length and form a frame-like shape as a whole as a whole. Specifically, the end surfaces of each frame piece 13S are in contact with the end surfaces of the adjacent frame pieces 13S at the respective joint portions. Therefore, the mechanical strength of the frame 13 further improves. Since the frame 13 is less likely to warp, high retention force is applied to all around the liquid crystal panel 11, the optical members 15, and the light guide plate 16 that are held between the frame 13 and the chassis 14 at a stable and even level. Furthermore, the screw members SM are attached in the Z-axis direction, namely, the overlapping direction of the liquid crystal panel 11, the optical members 15, and the light guide plate 16. Therefore, retention force is directly applied to the members 11, 15, and 16 from the overlapping direction. With the above configurations, the liquid crystal panel 11, the optical members 15, and the light guide plate 16 can be attached to one another in tight and at an even level over the entire surfaces. Consequently, amount of light supplied to the display surface 11c in the liquid crystal panel 11 may be evened in the surface and thus display quality of the displayed images may be maintained at a high level.

As described above, unlike the conventional configuration, the liquid crystal display device 10 according to this embodiment does not include the panel receiving member between the liquid crystal panel 11 and the light guide plate 16. In this configuration, a space on the liquid crystal panel 11 side communicates with a space on the LEDs 17 side. Light from the LEDs 17 may enter the liquid crystal panel 11 from the end surface without traveling through the light guide plate 16. However, as illustrated in FIG. 4, the frame 13 according to this embodiment includes the light guide plate holding portion 23 arranged between the LEDs 17 and the liquid crystal panel 11. With this configuration, light from the LEDs 17 hardly enters the liquid crystal panel 11 from the end surface thereof without traveling through the light guide plate 16. Therefore, reduction in display quality due to light leakage is less likely to occur. Moreover, the light guide plate holding portion 23 holds the light guide plate 16 along the peripheral end portion of the light guide plate 16 between with the chassis 14. Therefore, the positional relationship between the LEDs 17 and the light entrance surface 16b of the light guide plate 16 in the Z-axis direction can be stabilized. Accordingly, a light-entering-efficiency of the light that is emitted from the LEDs 17 and enters to the light entrance surface 16b can also be stabilized.

While the liquid crystal display device 10 is in use, heat is generated from the lightened LEDs 17. As illustrated in FIG. 6, the heat generated from the LEDs 17 is transferred to the heat dissipation member 19 through the LED board 18. Since the heat dissipation member 19 is attached to both of the screw attachment portion 21 of the frame 13 and the screw mount portion 14b1 of the LED housing 14b in the chassis 14, the heat from the LEDs 17 is transferred from the heat dispassion member 19 to the screw attachment portion 21 and the screw mount portion 14b1. The screw attachment portion 21 continues to the sidewall 13b of the frame 13 through the protrusion 22 but do not continue to the panel holding portion 13a directly. Specifically, the screw attachment portion 21 is arranged opposite the panel holding portion 13a with a predetermined space therebetween. In this configuration, most of the heat transferred to the screw attachment portion 21 is transferred to the sidewall 13b. Therefore, temperature increase in the panel holding portion 13b can be suppressed. Because the panel holding portion 13a is located on the front side of the frame 13 in the liquid crystal display device 10, that is, a portion facing the user, an outer object is more likely to touch the panel holding portions 13a compared to the sidewalls 13b. However, since temperature increase is less likely to occur in the panel holding portions 13a according to this embodiment, heat hardly affects the external object even if the external object touches the panel holding portions 13a. The temperature suppression in the panel holding portion 21 is highly effective for the frame 13 in this embodiment because the frame 13 is made of metal to provide sufficient mechanical strength and has high heat conductivity. With the above configurations, temperature increase in the panel holding member 13a can be suppressed and heat from the LEDs 17 can be effectively released to the outside by using heat capacity of the sidewalls 13b of the frame 13 and the chassis 14.

As described above, the liquid crystal display device (display device) 10 according to this embodiment includes the LEDs (light sources) 17, the liquid crystal panel (display panel) 11, the light guide plate 16, the holding member HM, the screw members (fixing member) SM, and the screw attachment portions (fixing member attachment portion) 21. The liquid crystal panel 11 is configured to provide a display using light from the LEDs 17. The light guide plate 16 is arranged on the side opposite to the display surface 11c side of the liquid crystal panel 11. The light guide plate 16 has the end surface that is arranged opposite the LEDs 17. The holding member HM includes the frame 13 and the chassis 14 (holding portions) that hold the liquid crystal panel 11 and the light guide plate 16 from the display surface 11c side and the side opposite to the display surface 11c side and houses the LEDs 17 therebetween. The screw members SM are attached to the outer peripheral portion of each of the frame 13 and the chassis 14 and hold the frame 13 and the chassis 14 in an assembled condition. The outer peripheral portions of the frame 13 and the chassis 14 surround the liquid crystal panel 11. The screw attachment portion 21 is arranged on the frame 13 (one of the holding portions) and held by the screw member SM with the chassis 14 (another one of the holding portions) sandwiched between the screw attachment portion 21 and the fixing member SM. The screw attachment portion 21 protrudes from an inner surface of the frame 13 (one of the holding portions) and extends along a side of the outer peripheral portion of the frame 13 (the one of the holding portions).

With the above configuration, the light emitted from the LED 17 enters the light guide plate 16 from the edge surface thereof opposite the LED 17 and passes through the light guide plate 16 toward the liquid crystal panel 11. An image is thus displayed on the liquid crystal panel 11 using the light. Unlike the conventional configuration in which the panel-receiving member is arranged between the liquid crystal panel and light guide plate 16, the liquid crystal panel 11 and the light guide plate 16 are arranged so as to overlap each other and held by the holding member HM in this embodiment. Specifically, the holding portions, which are the frame 13 and the chassis 14, included in the holding member HM sandwich the liquid crystal panel 11 and the light guide plate 16 from the display surface 11c side and the side opposite from the display surface 11c side. Therefore, the overall strength may be decreased by a strength that would have been provided by the panel-receiving member. Furthermore, the positional relationship between the liquid crystal panel 11 and the light guide plate 16 in the overlapping direction thereof, which would have been maintained by the panel-receiving member, may not be maintained in a stable condition. Therefore, the display quality may be reduced. However, according to the above configuration, the screw attachment portions 21 protrude from the inner surface of the frame 13 (the one of the holding portions) and extend along the edges of the outer peripheral portion of the frame 13. The screw member SM is attached to the screw attachment portion 21 with the chassis 14 (the other one of the holding portions) between the screw attachment portion 21 and the screw member SM. Therefore, strength of the frame 13 (the one of the holding portions) improves and accordingly the entire strength also improves. Furthermore, deformation is less likely to occur in the frame 13 (the one of the holding portions) in this configuration so that an improved retention force can be applied to the liquid crystal panel 11 and the light guide plate 16 that are held between the frame 13 (the one of the holding portions) and the chassis 14 (the other one of the holding portions). Because the positional relationship between the liquid crystal panel 11 and the light guide plate 16 can be stabilized, the display quality can be enhanced. Therefore, according to this embodiment, retention can be improved and display quality can be enhanced.

The screw members SM are attached to the outer peripheral portions of the frame 13 and the chassis 14 (the holding portions) in the overlapping direction of the liquid crystal panel 11 and the light guide plate 16. In this configuration, the screw members SM apply retention force through the frame 13 and the chassis 14 to the liquid crystal panel 11 and the light guide plate from the overlapping direction (the holding portions). Therefore, the positional relationship between the liquid crystal panel 11 and the light guide plate 16 in the overlapping direction can be stabilized and thus the display quality is further improved.

The frame 13 (one of the holding portions) is arranged on the display surface 11c side with respect to the liquid crystal panel 11. The chassis 14 (other one of the holding portions) is arranged on the side opposite to the display surface 11c side with respect to the light guide plate 16. The screw members SM are attached to the outer peripheral portions of the frame 13 and the chassis 14 (the holding portions) from the side opposite to the display surface 11c side. In this configuration, in the production process, the liquid crystal panel 11, the light guide plate 16, and the chassis 14 (the other of the holding portions) that is to be arranged on the side opposite from the display surface 11c side are attached to the frame 13 (the one of the holding portions) that is to be arranged on the display surface 11c side, in this sequence. The screw members SM are attached to the screw attachment portion 21 from the side opposite from the display surface 11c side. Therefore, higher assembling workability and productivity can be obtained.

The frame 13 and the chassis 14 (holding portions) are the exterior members that provide the appearance of the liquid crystal display device 10. In the above configuration, the frame 13 and the chassis 14 (the holding members) constitute the exterior member and a cabinet is not provided. Therefore, higher strength is required compared to the configuration in which a cabinet as an exterior member is provided in addition to the frame 13 and the chassis 14 (the holding members). However, the strength of the frame 13 (the one of the holding members) can be sufficiently increased by the screw attachment portion 21 in the above configuration. Furthermore, the configuration without the cabinet can reduce production cost and thickness of the liquid crystal display device 10.

The frame 13 (one of the holding portions) includes the panel holding portions 13a that press the liquid crystal panel 11 from the display surface 11c side and includes the sidewalls 13b that protrude from an area of the panel holding portion 13a that corresponds to the outer peripheral portion of the frame 13 toward the side opposite to the display surface 11c side. The screw attachment portion 21 is with the LEDs 17 attached thereto continues to the sidewall 13b with a space provided between the screw attachment portion 21 and the panel holding portion 13a. In this configuration, heat generated by the lightened LED 17 is transferred to the screw attachment portion 21 to which the LEDs 17 are attached. The heat is then transferred to the sidewall 13b that continues to the screw attachment portion 21. The heat is thus released to the outside. Since the space is provided between the screw attachment portion 21 and the panel holding portion 13a, the heat is less likely to be transferred to the panel holding portion 13a. The panel holding portion 13a that holds the liquid crystal panel 11 from the display surface 11c side is an exterior member and exposed to outside. Therefore, an external object is more likely to touch. However, the temperature increase is suppressed as described above and thus the external object that touches the panel holding portion 13a is less likely to be affected by heat.

The screw attachment portion 21 protrudes inward from an inner surface of the sidewall 13b with a space provided between the screw attachment portion 21 and the inner surface of the sidewall 13b. The chassis 14 (other one of holding portions) includes a side plate 14b2 (positioning portion) arranged in the space between the fixing member attachment portion and the inner surface of the sidewall 13b. In this configuration, in the assembly process of the chassis 14 (the other of the holding portions), the side plates 14b2 is arranged in the space provided between the screw attachment portion 21 and the sidewall 13b, and thus the chassis 14 (the other of the holding portions) can be positioned with respect to the frame 13 (the one of the holding portions). Therefore, high assembling workability can be achieved.

The liquid crystal display device further includes the heat dissipation member (light source attachment member) 19 including the LED attachment portion (light source attachment portion) to which the LEDs 17 are attached and the heat dissipation portion 19b. The heat dissipation portion 19b extends from the LED attachment portion 19a along the surface of the outer peripheral portion of the chassis 14 (the other one of the holding portions). The heat dissipation portion 19b is sandwiched between the outer peripheral portion of the chassis 14 (the other one of the holding portions) and the screw attachment portion 21 and held by the screw member SM. In this configuration, the LEDs 17 are attached to the screw attachment portion 21 via the heat dissipation member 19. Heat generated by the lightened LEDs 17 is transferred from the LED attachment portion 19a to the heat dissipation portion 19b. The heat is then transferred not only to the sidewall 13b that continues to the screw attachment portion 21 but also to the outer peripheral portion of the chassis 14 (the other of the holding portions). The heat is thus released to the outside. Therefore, heat is further less likely to be transferred to the panel holding portion 13a.

The frame 13 (one of the holding portions) is arranged on the display surface 11c side with respect to the liquid crystal panel 11. The chassis 14 (other one of the holding portions) is arranged on the side opposite to the display surface 11c side with respect to the light guide plate 16. The screw members SM are attached to the outer peripheral portions of the frame 13 and the chassis 14 (the holding portions) from the side opposite to the display surface 11c side. With this configuration, the screw member SM is hardly recognized from the display surface 11c side, and thus the liquid crystal display device 10 obtains a good appearance. Further, in assembling processes, the liquid crystal panel 11, the light guide plate 16, and the chassis 14 (the other of the holding portions) to be arranged on the side opposite from the display surface 11c side are attached to the frame 13 (the one of the holding portions) to be arranged on the display surface 11c side in this sequence. The screw member SM is then attached to the screw attachment portion 21 from the side opposite from the display surface 11c side. Therefore, high assembling workability and productivity can be obtained.

The screw attachment portions 21 extend along the sides of the outer peripheral portion of the frame 13 (one of the holding portions) over an entire length thereof and continues to the inner surface of the outer peripheral portion of the frame 13 (one of the holding portions). With this configuration, strength of the frame 13 (the one of the holding portions) further improves.

The frame 13 (one of the holding portions) is arranged on the display surface 11c side with respect to the liquid crystal panel 11 and has a frame-like shape so as to surround the liquid crystal panel 11. The frame 13 (one of the holding portions) are assembled from a plurality of frame pieces (holding pieces) 13S are bar parts of the frame 13. The screw attachment portion 21 includes a plurality of screw attachment portions, adjacent ones of which are in contact with each other, each of the screw attachment portions 21 is included in corresponding one of the frame pieces 13S. In this configuration, the frame 13 (the one of the holding portions) having a frame-like shape includes frame pieces 13S corresponding to the respective sides, and the each frame piece 13S includes the screw attachment portion 21. Therefore, the frame 13 (the one of the holding portions) having a complex shape can be easily produced. Moreover, the adjacent screw attachment portions 21 are in contact with each other and thus strength of the frame 13 (the one of the holding portions) further improves.

The display device further includes the heat dissipation member 19 to which the LEDs 17 is attached. The screw member SM is attached to the screw attachment portion 21 with the outer peripheral portion of the chassis 14 (the other one of the holding portions) and the heat dissipation member 19 sandwiched between the screw member SM and the fixing member attachment portion. With this configuration, the screw member SM can hold not only the frame 13 and the chassis 14 (the holding members) in an assembled condition but also the heat dissipation member 19.

The heat dissipation member 19 includes the heat dissipation portion 19b and the LED attachment portion 19a to which the LEDs 17 are attached. The heat dissipation portion extends along the surface of the outer peripheral portion of the chassis 14 (the other one of the holding portions). The heat dissipation portion is sandwiched between the outer peripheral portion of the chassis 14 (the other one of the holding portions) and the screw attachment portion 21 and held by the screw member SM. The LED attachment portion 19a extends from the heat dissipation portion 19b in the overlapping direction of the liquid crystal panel 11 and the light guide plate 16. The LED attachment portion 19a is in contact with inner surfaces of the outer peripheral portions of the frame 13 and the chassis 14 (the holding portions) facing to each other. In this configuration, the light source attachment portion 19a of the heat dissipation member 19 is in contact with the respective inner surfaces of the outer peripheral portions of the frame 13 and the chassis 14 (the holding members) that face to each other. Therefore, strength of the frame 13 and the chassis 14 (the holding members) further improves. Furthermore, heat generated by the lightened LEDs 17 is transferred to the chassis 14 (the other of the holding portions) and the screw attachment portion 21 via the light source attachment portion 19a and the heat dissipation portion 16b. Thus, heat can be released.

The liquid crystal display device includes the flexible boards 26 and the printed circuit boards 27. The flexible boards 26 are connected to the end of the liquid crystal panel 11. The printed circuit boards 27 are connected to the end of the flexible boards 26 on the side opposite to the side closer to the liquid crystal display panel 11. The heat dissipation member 19 includes the heat dissipation portion 19b and the LED attachment portion 19a. The heat dissipation portion 19b extends along the surface of the outer peripheral portion of the chassis 14 (the other one of the holding portions). The heat dissipation portion 19b is sandwiched between the outer peripheral portion of the chassis 14 (the other one of the holding portions) and the screw attachment portion 21 and held by the screw member SM. The LED attachment portion 19a extends from the heat dissipation portion 19b in the overlapping direction of the liquid crystal panel 11 and the light guide plate 16. The LEDs 17 are attached to the LED attachment portion 19a. The LED attachment portion 19a is arranged with the board space BS between the LED attachment portion 19a and the screw attachment portion 21. The board space BS is configured to house the printed circuit board 27 therein. With this configuration, the printed circuit board 27 connected to the flexible board 26 can be arranged in the board space BS that is provided between the LED attachment portion 19a and the screw attachment portion 21. Furthermore, heat generated from the lightened LEDs 17 is transferred to the chassis 14 (the other of the holding portions) and the screw attachment portion 21 via the light source attachment portion 19a and the heat dissipation portion 16b. Thus heat can be released.

One of the holding members, that is, the frame 13 or the chassis 14, arranged on the display surface 11c side includes the light guide plate holding portions 23 that are in contact with the surface of the light guide plate 16 on the display surface 11c side. In this configuration, the light guide plate holding portions 23 hold the light guide plate 16 from the liquid crystal panel 11 side. Therefore, the light guide plate 16 can be held in a more stable condition, and thus the positional relationship between the light guide plate 16 and the LEDs 17 can be more stabilized.

### Second Embodiment

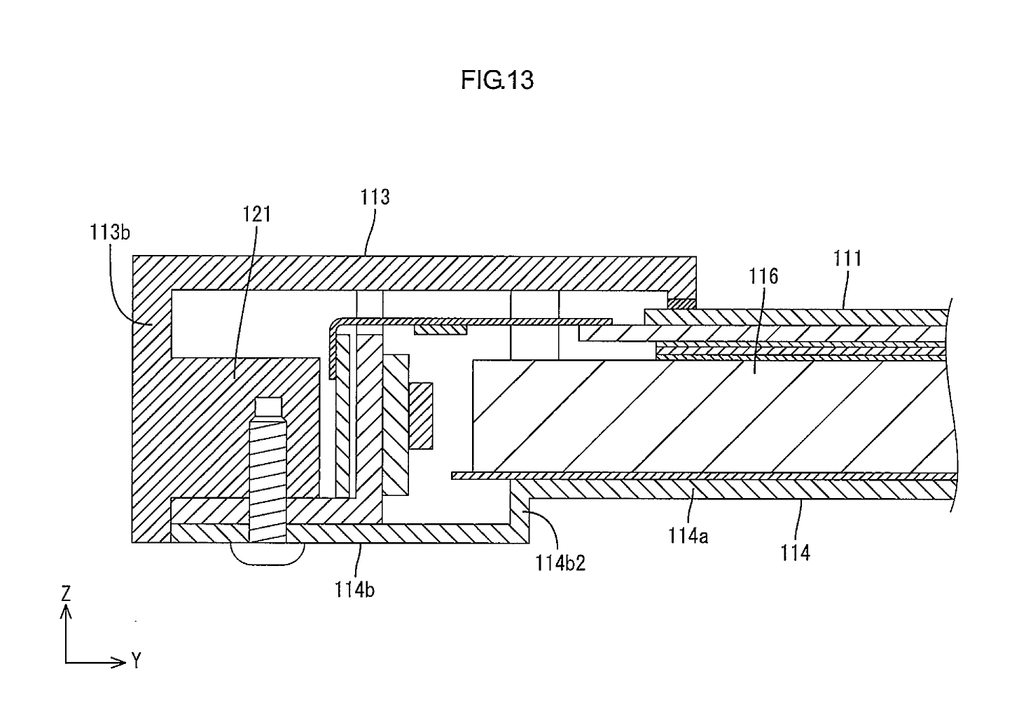

The second embodiment of the present invention will be described with reference to FIG. 13. In the second embodiment, a screw attachment portion 121 is continuous with a sidewall 113b without any spaces therebetween. The other constructions, advantages, and effects same as those in the first embodiment will not be described.

As illustrated in FIG. 13, the screw attachment portion 121 according to this embodiment has an exterior side surface that is continuous with an inner surface of the sidewall 113b of a frame 113 over its entire area. Unlike the above first embodiment, there is no space between the screw attachment portion 121 and the sidewall 113b. In other words, the screw attachment portion 121 protrudes inwardly from the inner surface of the sidewall 113b in the X-axis direction or the Y-axis direction (a direction perpendicular to an overlapping direction of a liquid crystal panel 111 and a light guide plate 116) and is continuous with the sidewall 113b over its entire height. With this configuration, the sidewall 113b can have a higher mechanical strength. In this configuration, an LED housing 114b of a chassis 114 includes a side plate 114b2, which extends from a bottom plate portion 114a, only at an inner edge thereof. Unlike the above first embodiment, the LED housing 114b does not include the side plate 14b2 (see FIG. 6) at the outer edge thereof.

### Third Embodiment

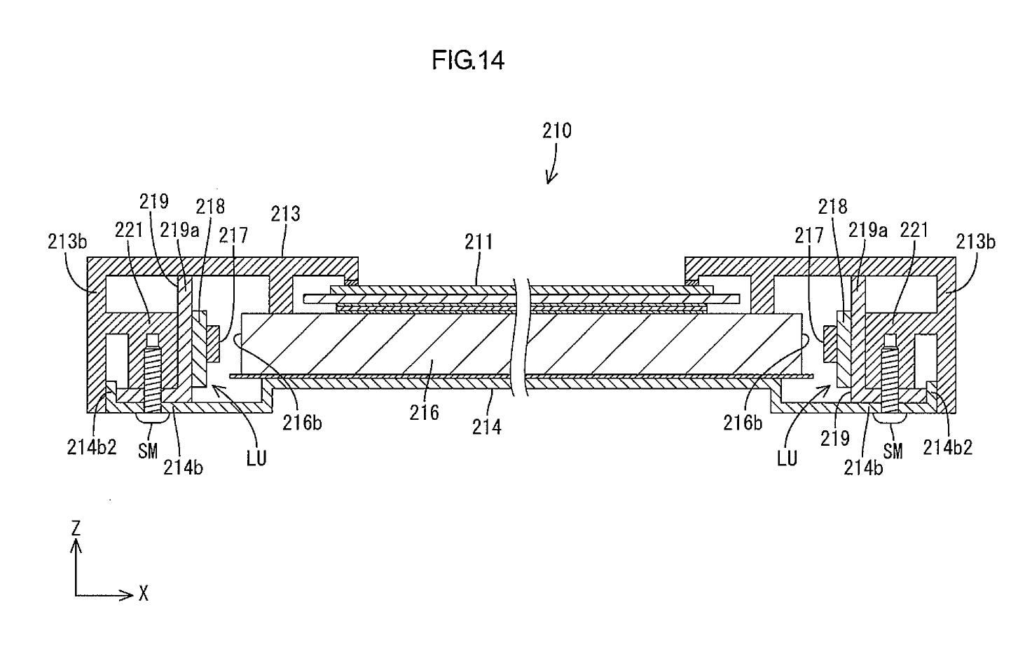

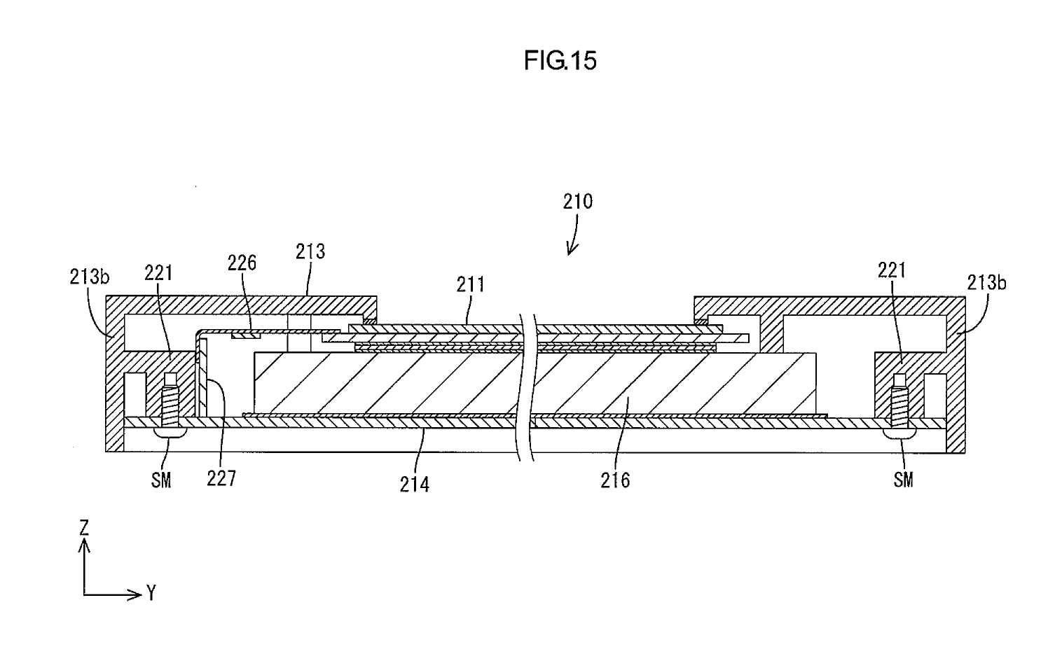

The third embodiment of the present invention will be described with reference to FIG. 14 or FIG. 15. In the third embodiment, an arrangement of a pair of LED units LU is different from that in the above first embodiment. The other constructions, advantages, and effects same as those in the first embodiment will not be described.

As illustrated in FIG. 14, the LED units LU according to this embodiment are each arranged along each short side of a liquid crystal display device 210 such that a light guide plate 216 is located between the LED units LU, which are disposed on the respective sides, in the long-side direction (the X-axis direction). Each of an LED board 218 and a heat dissipation member 219 included in the LED unit LU extends in the short-side direction of the light guide plate 216. LEDs 217 are arranged in line on the LED board 218 in the length direction of the LED board 218 (the Y-axis direction) at intervals. Each LED unit LU is attached to each screw attachment portion 221 that is disposed on the short side of a frame 213 with the screw member SM. Outer peripheral end surfaces of the light guide plate 216 include short-side end surfaces that face the LEDs 217 included in each LED unit LU and serve as light entrance surfaces 216b. The chassis 214 includes a pair of LED housings 214b, which house the LED units LU, on the short-side ends thereof. The LED housing 214b includes an exterior side plate 214b2 that is disposed in a space between the screw attachment portion 221 that is on the short side and to which the LED unit LU is attached and the sidewall 213b of the frame 213 that is on the short side.

As illustrated in FIG. 14 and FIG. 15, each LED unit LU is disposed on each short side of the liquid crystal device 210, and thus the LED units LU do not overlap a flexible board 226, which is connected to the liquid crystal panel 211, in a plan view. In this configuration, unlike the above first embodiment, the heat dissipation member 219 included in each LED unit LU is attached such that an LED attachment portion 219a is in contact with the screw attachment portion 221 without a space (the board space BS) therebetween. As illustrated in FIG. 15, a printed circuit board 227 that is connected to a flexible board 226 is in contact with and attached to an inner side surface of the screw attachment portion 221 that is on the long side. With this configuration, the liquid crystal display device 210 can have a smaller frame width. In addition, due to the above positional relationship, unlike the above first embodiment, the heat dissipation member 219 included in each LED unit LU has no flexible board insertion hole 19a1 (see FIG. 6). With this configuration, all of the heat dissipation members 219 included in the LED units LU can be the same (common parts), and thus the production cost of the heat dissipation member 219 can be reduced.

### Fourth Embodiment

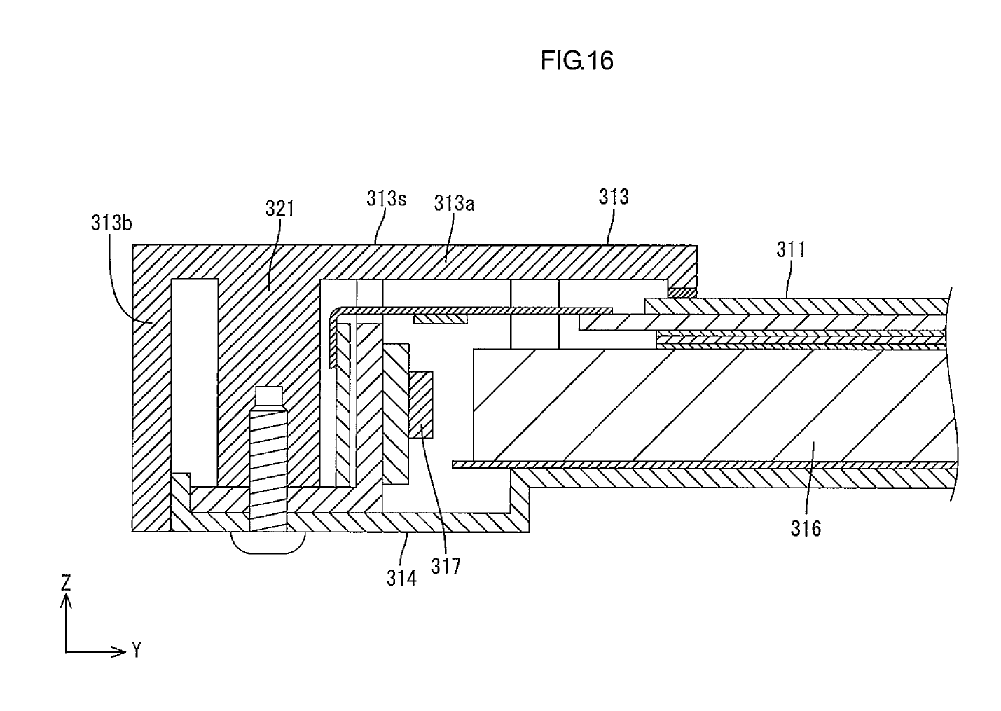

A fourth embodiment according to the present invention will be described with reference to FIG. 16. In the fourth embodiment, a screw attachment portion 321 is continuous with a panel holding portion 313a of a frame 313. The other constructions, advantages, and effects same as those in the first embodiment will not be described.

As illustrated in FIG. 16, the screw attachment portion 321 according to this embodiment is formed into a single member so as to be continuous with an outer peripheral portion of the panel holding portion 313 included in the frame 313, specifically, at a position more interior than a sidewall 313b (a position away from the sidewall 313b toward a light guide plate 316). The screw attachment portion 321 protrudes from an inner surface of the panel holding portion 313a toward a rear side in the Z-axis direction (an overlapping direction of a liquid crystal panel 311 and the light guide plate 316). The screw attachment portion 321 has an elongated block-like shape and extends along each side of the panel holding portion 313a over its entire length. The screw attachment portion 321 is provided for each divided frame 313S included in the frame 313. The screw attachment portions 321 form a frame-like shape that extends along the inner surface of the panel holding portion 313a over the entire length when the frame pieces 313S are assembled. With this configuration, the screw attachment portion 321 can directly improve the mechanical strength of the panel holding portion 313a of the frame 313 and thus a liquid crystal panel 311 and a light guide plate 316 that are located between the frame 313 and a chassis 314 can have further improved retention. Heat from an LED 317 can be transferred to the chassis 314 and the panel holding portion 313a of the frame 313 via the screw attachment portion 321 and released to the outside.

### Fifth Embodiment

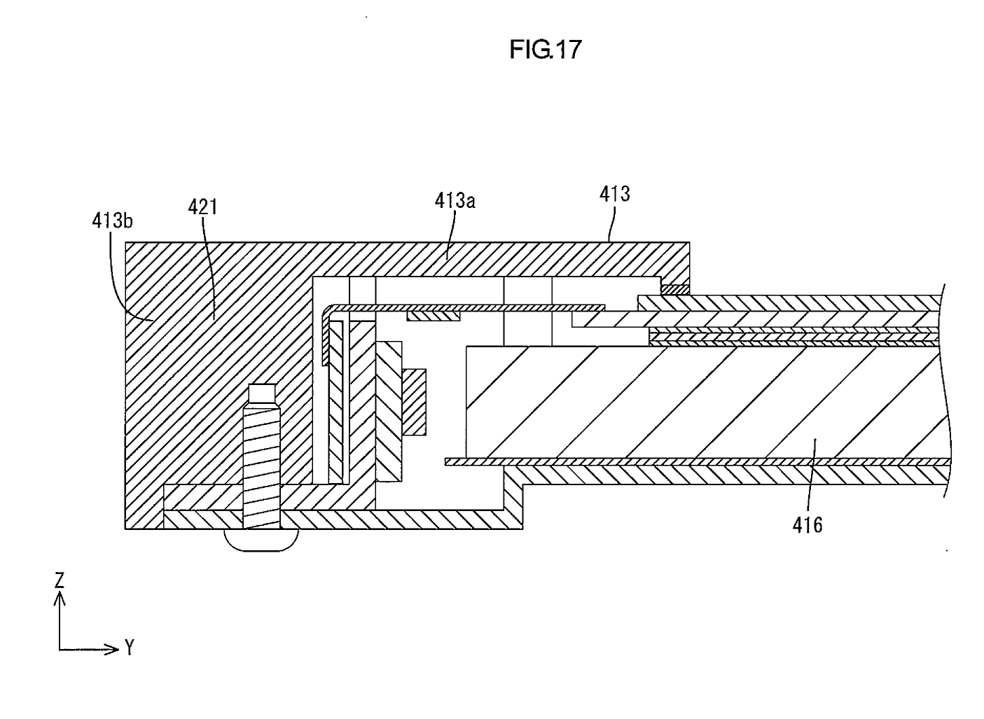

A fifth embodiment according to the present invention will be described with reference to FIG. 17. In the fifth embodiment, a screw attachment portion 421 is continuous with both of a panel holding portion 413a and a sidewall 413b of a frame 413. The other constructions, advantages, and effects same as those in the first embodiment will not be described.

As illustrated in FIG. 17, the screw attachment portion 421 according to this embodiment is formed so as to be continuous with both of an inner surface of an outer peripheral portion of the panel holding portion 413a included in the frame 413 and an inner surface of the sidewall 413b. A front surface of the screw attachment portion 421 faces toward the front side and is continuous with the inner surface of the panel holding portion 413a over the entire area. A side surface of the screw attachment portion 421 faces toward the outside (a side opposite to the light guide plate 416) and is continuous with an inner surface of the sidewall 413b over the entire area. In other words, the panel holding portion 413a and the sidewall 413b form an L-like shape in a cross section, and the screw attachment portion 421 is continuous over a bend portion between the panel holding portion 413a and the sidewall 413b. With this configuration, the frame 413 can have a higher mechanical strength than that in any one of the above first to fourth embodiments.

### Sixth Embodiment

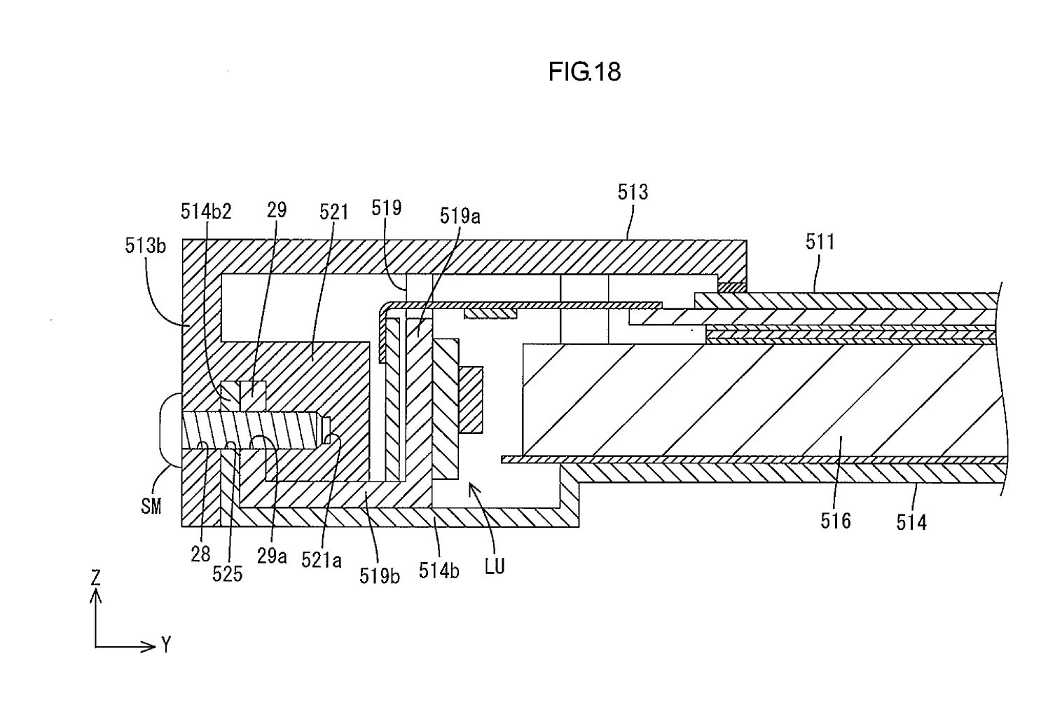

A sixth embodiment according to the present invention will be described with reference to FIG. 18. In the sixth embodiment, an attachment direction of the screw member SM is changed. The other constructions, advantages, and effects same as those in the first embodiment will not be described.

As illustrated in FIG. 18, the screw member SM is attached to a screw attachment portion 521 of this embodiment from a side in the X-axis direction or the Y-axis direction (a direction perpendicular to an overlapping direction of a liquid crystal panel 511 and a light guide plate 516). The screw attachment portion 521 includes a groove 521a that opens to the outside in the X-axis direction or the Y-axis direction to receive the screw member SM. A side plate 514b2 located at the outer side of the LED housing 514b included in the chassis 514 includes a screw insertion hole 525 that is a hole communicating with the above-described screw insertion hole 28 and the groove 521a. The heat dissipation member 519 included in the LED unit LU includes a side plate 29 that extends from an outer end (a side opposite from the side of the LED attachment portion 519a) of a heat dissipation portion 519b along the side surface of the screw attachment portion 521. The side plate 29 includes the screw attachment hole 29a that is a hole communicating with the above-described screw insertion holes 28, 525 and the groove 521a. The screw member SM is passed through the screw insertion holes 28, 29a, 525 from the outer side of the sidewall 513b and fastened to the groove 521a.

### Other Embodiments

The present invention is not limited to the embodiments described in the above description with reference to the drawings. The following embodiments may be included in the technical scope of the present invention, for example.

(1) In the above embodiments, the screw attachment portion extends along the inner surface of the frame in the extending direction thereof over the entire length of the frame. However, the screw attachment portion may extend along parts of the inner surface of the frame in the extending direction thereof.

(2) In the above embodiments, the screw attachment portions each have the length equal to the entire length of the respective sides of the frame. However, the screw attachment portions each may have a length shorter than the length of the respective sides of the frame. In such a case, multiple screw attachment portions may be disposed on each side of the frame.

(3) In the above embodiments, the screw attachment portion is disposed on every side of the frame. However, the screw attachment portion may be disposed on a predetermined side of the frame, and no screw attachment portion may be disposed on the other sides of the frame. In such a case, the screw attachment portion may be disposed on the side of the frame that overlaps the LED unit in a plan view, or on the side of the frame that does not overlap the LED unit in a plan view. If the latter is employed, a separate attachment structure that is configured to attach the LED unit is required.

(4) According to a modified fourth embodiment, a protrusion having the similar configuration as that in the above first embodiment may be provided on the inner surface of the panel holding portion. Only a part of the front surface (the surface facing the panel holding portion) of the screw attachment portion may be continuous with the protrusion. This configuration may also be applied to the configuration of the above fifth embodiment (in which the screw attachment portion is continuous with both of the panel holding portion and the sidewall).

(5) In the above embodiments, the space into which the side plate of the chassis is inserted is provided between the screw attachment portion to which the LED unit is attached and the sidewall. However, the space may be provided between each screw attachment portion and each sidewall, and the chassis may include side plates at its outer edges such that the side plates are inserted into the space. With this configuration, the chassis can be positioned with respect to the frame in the X-axis direction and the Y-axis direction.

(6) In the above embodiments, the LED unit includes the heat dissipation member. However, the heat dissipation member may be eliminated and the LED board may be directly attached to the chassis or the frame (the screw attachment portion). In such a case, the LED board may have an L-like shape in a cross-section similar to the above heat dissipation member. The LED board may include an LED attachment portion on which the LED is mounted and a heat dissipation portion that is in contact with the plate surface of the chassis.

(7) If the configuration described in the above (6) in which the heat dissipation member is eliminated is applied to the above third embodiment, the LED board may only include the LED attachment portion, and the LED attachment portion may be directly attached to the side surface of the screw attachment portion.

(8) In the above embodiments, the screw attachment portion and the frame are formed together as a single member. However, the screw attachment portion may be a different member from the frame and may be attached to the frame. In such a case, the screw attachment portion may be made of metal similar to the frame, or the screw attachment portion may be made of synthetic resin different from the frame.

(9) Other than the above embodiments, the joint position of the frame pieces of the frame and the shape of the joint may be properly changed. For example, the shape of the joint of the frame pieces may be a straight line extending in the X-axis direction or a straight line extending in the Y-axis direction.

(10) In the above embodiments, the frame includes the frame pieces. However, the frame may be a single member. In such a case, in the production of the frame made of metal, preferably, a flat plate may be formed into an intended shape by a bending, a pressing, or a drawing

(11) In the above embodiments, the LED attachment portion of the heat dissipation member included in the LED unit is in contact with the inner surface of the panel holding portion. However, the LED attachment portion may not be in contact with the inner surface of the panel holing portion, and the LED attachment portion may be away from the inner surface of the panel holding portion with a space therebetween.

(12) In the above embodiments, the screw member is attached from the rear side of the chassis in the Z-axis direction, or attached from the side of the frame in the X-axis direction or the Y-axis direction. However, the screw member may be attached from the front side of the frame in the Z-axis direction. In such a case, preferably, the screw attachment portion is attached to the chassis.

(13) In the above embodiments, the end portion of the chassis includes the LED housing that protrudes such that the chassis has a step. However, the chassis may not include the step, and the end portion of the bottom plate may receive the LED unit.

(14) In the above embodiments, the chassis and the heat dissipation member are fastened together to the projection by the screw member. However, a screw member that is configured to fasten the chassis to the screw attachment portion and another screw member that is configured to fasten the heat dissipation member to the screw attachment portion may be provided.

(15) Other than the above embodiments, an arrangement of the LED unit (the LED board, the heat dissipation member) may be properly changed. The LED unit may be arranged to face an end portion that extends along one of the long sides or one of the short sides of the light guide plate. The LED units may be arranged to face end portions that extend along any three of the sides of the light guide plate. The LED unit may be arranged to face end portions that extend along all of four sides of the light guide plate.

(16) In the above embodiments, two LED units (the LED boards, the heat dissipation members) are provided for one side of the light guide plate. However, one or three or more LED units may be provided for one side of the light guide plate.

(17) In the above embodiments, the frame and the chassis are exterior members that provide the exterior appearance of the liquid crystal display device. However, a different exterior member may cover a rear surface of the chassis such that the chassis are not exposed to the outside. Alternatively, an additional exterior member that is provided may cover the frame and the chassis such that the frame and the chassis are not exposed to the outside.

(18) In the above embodiments, the chassis and the frame that are the exterior members are made of metal. However, one or both of the chassis and the frame may be made of synthetic resin. This configuration is preferably applied to a medium-size or small-size liquid crystal display device that does not require very high mechanical strength. The technical matter in which the frame is made of synthetic resin is preferably employed in combination with the configuration in which the frame is a single member as described in the above (10).

(19) In the above embodiments, the flexible board is connected to one of the long-side ends of the liquid crystal panel. However, the flexible board may be connected to each long-side end of the liquid crystal panel.

(20) Other than the above (19), the flexible board may be connected to only one of the short-side ends of the liquid crystal panel, the flexible board may be connected to each short-side end of the liquid crystal panel, the flexible board may be connected to any three of the side ends of the liquid crystal panel, or the flexible board may be connected to each one of four side ends of the liquid crystal panel.

(21) In the above embodiments, the power source board is configured to supply power to the LED. However, an LED drive board that is configured to supply power to the LED may be provided as a different member from the power source board.

(22) In the above embodiments, the main board includes the tuner. However, a tuner board including the tuner may be provided as a different member from the main board.

(23) In the above embodiments, the color filter of the liquid crystal panel includes three colors of color sections in red, green, and blue. However, the color filter may include four or more colors of color sections.

(24) In the above embodiments, the LED is used as a light source. However, a light source other than the LED, such as an organic EL, may be used.

(25) In the above embodiments, TFTs are used as switching components of the liquid crystal display device. However, the technology described above can be applied to liquid crystal display devices including switching components other than TFTs (e.g., thin film diode (TFD)). The technology can be applied to not only color liquid crystal display devices but also black-and-white liquid crystal display devices.

(26) In the above embodiments, the liquid crystal display device including the liquid crystal panel as a display panel is used. However, the technology can be applied to display devices including other types of display panels.

(27) In the above embodiments, the television receiver including the tuner is used. However, the technology can be applied to a display device without a tuner.

### EXPLANATION OF SYMBOLS

10, 210: liquid crystal display device (display device), 11, 111, 211, 311, 511: liquid crystal panel (display panel), 11c: display surface, 12: backlight unit (lighting device), 13, 113, 213, 313, 413, 513: frame (a pair of holding members, one of the holding portions, holding portion arranged on a display surface side), 13a, 313a, 413a: panel holding portion, 13b, 113b, 213b, 313b, 413b, 513b: sidewall (outer peripheral portion), 13S: frame piece (holding piece), 14, 114, 214, 314, 514: chassis (a pair of holding portions, the other one of the holding portions), 14a1: screw mount portion (outer peripheral portion), 14b1: screw mount portion (outer peripheral portion), 14b2, 214b2: side plate (positioning portion), 16, 116, 216, 316, 416, 516: light guide plate, 17, 217, 317: LED (light source), 19, 219, 519: heat dissipation member (light source attachment member), 19a, 219a, 519a: LED attachment portion (light source attachment portion), 19b, 519b: heat dissipation portion, 21, 121, 221, 321, 421, 521: screw attachment portion (fixing member attachment portion), 23: light guide plate holding portion, 26, 226: flexible board, 27, 227: printed circuit board, BS: board space, SM: screw member (fixing member), HM: holding member, TV: television device.

1. A display device comprising:
a light source;
a display panel configured to provide a display using light from the light source;
a light guide plate arranged on a side opposite to a display surface side of the display panel, the light guide plate having an end surface being arranged opposite the light source;
a holding member including holding portions that holds the display panel and the light guide plate from the display surface side and the side opposite to the display surface side and houses the light source therebetween;
a fixing member attached to an outer peripheral portion of each of the holding portions and holding the holding portions in an assembled condition, the outer peripheral portion of each of the holding portions surrounding the display panel; and
a fixing member attachment portion arranged on one of the holding portions and being held by the fixing member with another one of the holding portions sandwiched between the fixing member attachment portion and the fixing member, the fixing member attachment portion protruding from an inner surface of the one of the holding portions and extending along a side of the outer peripheral portion of the one of the holding portions.

2. The display device according to claim 1, wherein the fixing member is attached to the outer peripheral portion of each of the holding portions in an overlapping direction of the display panel and the light guide plate.

3. The display device according to claim 2, wherein
the one of the holding portions is arranged on the display surface side with respect to the display panel,
the other one of the holding portions is arranged on the side opposite to the display surface side with respect to the light guide plate, and
the fixing member is attached to the outer peripheral portion of each of the holding portions from the side opposite to the display surface side.

4. The display device according to claim 1, wherein the holding portions are exterior members that provides an appearance of the display device.

5. The display device according to claim 4, wherein
the one of the holding portions includes:
a panel holding portion pressing the display panel from the display surface side; and
a sidewall protruding toward the side opposite to the display surface side from an area of the panel holding portion corresponding to the outer peripheral portion of the one of the holding portions, and
the fixing member attachment portion with the light source attached thereto continues to the sidewall with a space provided between the fixing member attachment portion and the panel holding portion.

6. The display device according to claim 5, wherein
the fixing member attachment portion protrudes inward from an inner surface of the sidewall with a space provided between the fixing member attachment portion and the inner surface of the sidewall, and
the other one of holding portions includes a positioning portion arranged in the space between the fixing member attachment portion and the inner surface of the sidewall.

7. The display device according to claim 5, further comprising a light source attachment member including:
a light source attachment portion to which the light source is attached; and
a heat dissipation portion extending from the light source attachment portion along a surface of the outer peripheral portion of the other one of the holding portions, the heat dissipation portion being sandwiched between the outer peripheral portion of the other one of the holding portions and the fixing member attachment portion and being held by the fixing member.

8. The display device according to claim 4, wherein
the one of the holding portions is arranged on the display surface side with respect to the display panel,
the other one of the holding portions is arranged on the side opposite to the display surface side with respect to the light guide plate, and
the fixing member is attached to the outer peripheral portion of each of the holding portions from the side opposite to the display surface side.

9. The display device according to claim 1, wherein the fixing member attachment portion extends along the side of the outer peripheral portion of the one of the holding portions over an entire length thereof and continues to an inner surface of the outer peripheral portion of the one of the holding portions.

10. The display device according to claim 9, wherein
the one of the holding portions is arranged on the display surface side with respect to the display panel and has a frame-like shape so as to surround the display panel, the one of the holding portions assembled from a plurality of holding pieces that are bar parts of the one of the holding portions, and
the fixing member attachment portion includes a plurality of fixing member attachment portions, adjacent ones of which are in contact with each other, each of the plurality of fixing member attachment portions is included in corresponding one of the holding pieces.

11. The display device according to claim 1, further comprising a light source attachment member to which the light source is attached, wherein
the fixing member is attached to the fixing member attachment portion with the outer peripheral portion of the other one of the holding portions and the light source attachment member sandwiched between the fixing member and the fixing member attachment portion.

12. The display device according to claim 11, wherein
the light source attachment member includes:
a heat dissipation portion extending along a surface of the outer peripheral portion of the other one of the holding portions, the heat dissipation portion being sandwiched between the outer peripheral portion of the other one of the holding portions and the fixing member attachment portion and being held by the fixing member; and
a light source attachment portion to which the light source is attached, the light source attachment portion extending from the heat dissipation portion in the overlapping direction of the display panel and the light guide plate, wherein
the light source attachment portion is in contact with inner surfaces of the outer peripheral portions of the holding portions facing to each other.

13. The display device according to claim 11, further comprising:
a flexible board connected to an end of the display panel; and
a printed circuit board connected to an end of the flexible board on a side opposite to a side close to the display panel, wherein the light source attachment member includes:
a heat dissipation portion extending along the surface of the outer peripheral portion of the other one of the holding portions, the heat dissipation portion being sandwiched between the outer peripheral portion of the other one of the holding portions and the fixing member attachment portion and being held by the fixing member; and
a light source attachment portion to which the light source is attached, the light source attachment portion extending from the heat dissipation portion in the overlapping direction of the display panel and the light guide plate, wherein
the light source attachment portion is arranged with a board space between the light source attachment portion and the fixing member attachment portion, the board space being configured to house the printed circuit board therein.

14. The display device according to claim 1, wherein one of the holding portions arranged on the display surface side further includes a light guide plate holding portion being in contact with a surface of the light guide plate on the display surface side.

15. A television device comprising the display device according to claim 1.
